(19) United States
(12) Patent Application Publication
(10) Pub. No.: US 2016/0272843 A1
(43) Pub. Date: Sep. 22, 2016

(54) POLARIZING PLATE PROTECTIVE FILM, POLARIZING PLATE, LIQUID CRYSTAL DISPLAY DEVICE, AND METHOD FOR PREPARING POLARIZING PLATE PROTECTIVE FILM

(71) Applicant: FUJIFILM Corporation, Tokyo (JP)

(72) Inventors: Masaaki SUZUKI, Kanagawa (JP); Katsuyuki TAKADA, Kanagawa (JP); Ryo NAKAMURA, Kanagawa (JP); Hidenori HAYASHI, Kanagawa (JP); Yasuyuki SASADA, Kanagawa (JP)

(73) Assignee: FUJIFILM Corporation, Tokyo (JP)

(21) Appl. No.: 15/073,165

(22) Filed: Mar. 17, 2016

(30) Foreign Application Priority Data
Mar. 19, 2015 (JP) 2015-056757

(51) Int. Cl. C09D 135/02; G02B 1/14; G02F 1/1335; G02B 5/30

(52) U.S. Cl. CPC C09D 135/02; G02B 5/3033; G02B 1/14; G02F 1/133528

(57) ABSTRACT

There is provided a polarizing plate protective film including: a hard coat layer with a thickness of 3 to 10 μm on at least one surface of a cellulose acylate film with a thickness of 15 to 40 μm, wherein the hard coat layer is a layer formed by curing a composition for forming a hard coat layer containing specific components, and the polarizing plate protective film has a WVTR_{A} of 300 g/m²/day or less and a ratio WVTR_{A}/WVTR_{B} of 0.6 to 1.0, wherein WVTR_{A} represents a water vapor transmission rate under environments of a temperature of 40° C. and a relative humidity of 90% and WVTR_{B} represents a water vapor transmission rate under environments of a temperature of 40° C. and a relative humidity of 90% after being exposed to the environments of a temperature of 85° C. and a relative humidity of 85% for 24 hours.

### CROSS REFERENCE TO RELATED APPLICATION(S)

This application claims priority from Japanese Patent Application No. 2015-056757 filed on Mar. 19, 2015, the entire disclosures of which are incorporated herein by reference.

### BACKGROUND

1. Technical Field

The present invention relates to a polarizing plate protective film in which wet heat stability of the water vapor permeability is excellent, a polarizing plate, an image display device, and a method for preparing a polarizing plate protective film.

2. Related Art

Recently, liquid crystal display devices have been widely used for the use of a liquid crystal panel for liquid crystal televisions or personal computers, mobile phones, and digital cameras. Typically, the liquid crystal display device includes a liquid crystal panel member provided with polarizing plates at both sides of a liquid crystal cell, and display is performed by controlling light from a backlight member to a liquid crystal panel member. Here, a polarizing plate is composed of a polarizer and a protective film thereof, a general polarizer is obtained by dyeing a stretched polyvinyl alcohol (PVA)-based film with iodine or a dichroic dye, and a cellulose ester film and the like are used as the protective film.

For recent liquid crystal displays, along with higher quality, applications are also diversified, and thus requirements for durability are becoming stricter. For example, stability against environmental changes and improvement in hardness of a display surface are required in the use for outdoor applications, and an optical film, such as a protective film for a polarizing plate or an optically-compensatory film, used in a liquid crystal display device is also required to suppress a change in dimensions and optical characteristics for temperature or humidity change.

Japanese Patent Laid-Open Publication No. 2006-083225 describes a low water vapor-permeable film including a cured layer obtained by applying and curing a curable composition having a specific alicyclic hydrocarbon group and containing a compound having two unsaturated double bond group in the molecule on a transparent substrate film, in which the film has a water vapor transmission rate of approximately 321 g/m²/day.

Further, Japanese Patent Laid-Open Publication No. 2011-93133 describes a low water vapor-permeable hard coat film having a water vapor transmission rate of 20 to 280 g/m²/day.

In addition, Japanese Patent Laid-Open Publication No. H08-073771 describes that a radical polymerizable compound and a cationic polymerizable compound are used in a composition for forming a hard coat layer.

However, the resin composition described in Japanese Patent Laid-Open Publication No. 2006-083225 has a certain effect due to low water vapor permeability, but a polarizing plate is not in a sufficient level of wet heat durability under a more rigorous environment.

Further, Japanese Patent Laid-Open Publication No, 2011-93133 describes a low water vapor-permeable hard coat film, but since the hard coat layer is formed of urethane acrylate, and the like, the effect of reducing water vapor transmission rate as a hard coat layer is so inconspicuous that the hard coat film needs to be further improved as the thickness of a support has been recently decreased. Furthermore, in Japanese Patent Laid-Open Publication No. H08-073771, low water vapor permeability is not examined, and the durability as a polarizing plate protective film is not in a sufficient level.

Therefore, an object of the present invention is to provide a polarizing plate protective film which is low water vapor-permeable and excellent in surface hardness, and has excellent polarizing plate durability even under a rigorous wet heat environment, and a preparation method thereof. Further, another object of the present invention is to provide a polarizing plate and an image display device, which use the polarizing plate protective film.

### SUMMARY

Problems to be solved by the present invention may be solved by the following means.

[1] A polarizing plate protective film including: a hard coat layer having a film thickness of 3 μm to 10 μm on at least one surface of a cellulose acylate film having a thickness of 15 μm to 40 μm,

wherein the hard coat layer is a layer formed by curing a composition for forming a hard coat layer containing:

(a) a compound having at least one alicyclic epoxy group in molecule

(b) a compound having three or more ethylenically unsaturated double bond groups in molecule

(c) a radical polymerization initiator

(d) a cationic polymerization initiator, and

the polarizing plate protective film has a WVTR_{A} of 300 g/m²/day or less and a ratio WVTR_{A}/WVTR_{H} of 0.6 to 1.0 when a water vapor transmission rate under environments of a temperature of 40° C. and a relative humidity of 90% is defined as WVTR_{A} and a water vapor transmission rate under environments of a temperature of 40° C. and a relative humidity of 90% after being exposed to the environments of a temperature of 85° C. and a relative humidity of 85% for 24 hours is defined as WVTR_{B}.

[2] The polarizing plate protective film of [1], wherein the WVTR_{A} is less than 230 g/m²/day and the ratio WVTR_{A}/WVTR_{B} is 0.7 to 1.0.

[3] The polarizing plate protective film of [1] or [2],

wherein the compound (a) is represented by Formula (1) below, the compound (a) having an alicyclic epoxy group and an ethylenically unsaturated double bond group in molecule, and a molecular weight of 300 or less:

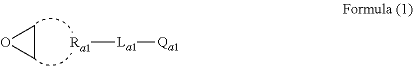

wherein in Formula (1), Rₐ₁ represents a monocyclic hydrocarbon, or a crosslinked hydrocarbon,

Lₐ₁ represents a single bond or a divalent linking group, and

Qₐ₁ represents an ethylenically unsaturated double bond group.

[4] The polarizing plate protective film of [1] or [2],

wherein the compound (a) includes a repeating unit represented by Formula (2) below and has a weight average molecular weight of 1,500 or more:

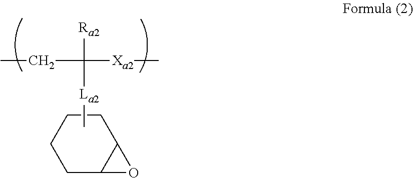

wherein in Formula (2), Rₐ₂ represents a hydrogen atom or a methyl group, Xₐ₂ represents a single bond, or an oxygen atom, an alkylene group which optionally has a substituent, an arylene group which optionally has a substituent, an aralkylene group which optionally has a substituent, an ester bond, a carbonyl bond, —NH—, or a linking group composed of a combination thereof, and

Lₐ₂ represents a single bond, or an alkylene group which optionally has a substituent, an arylene group which optionally has a substituent, an aralkylene group which optionally has a substituent, an ester bond, an ether bond, a carbonyl bond, —NH—, or a linking group composed of a combination thereof.

[5] The polarizing plate protective film of any one of [1] to [4],

wherein a content of the compound (a) is 10 mass % to 40 mass %, a content of the compound (b) is 35 mass % to 89.8 mass %, a content of the radical polymerization initiator (c) is 0.1 mass % to 10 mass %, and a content of the cationic polymerization initiator (d) is 0.1 mass % to 10 mass %, with respect to a total solid content in the composition for forming the hard coat layer.

[6] The polarizing plate protective film of any one of [1] to [5],

wherein the composition for forming the hard coat layer further contains (e) inorganic particles reactive with an epoxy group or an ethylenically unsaturated double bond group, the inorganic particles have an average particle diameter of 10 nm to 100 nm and is contained in an amount of 5 mass % to 40 mass % with respect to a total solid content in the composition for forming the hard coat layer. [7] The polarizing plate protective film of any one of [1] to [6],

wherein a maximum absorption wavelength λc of the radical polymerization initiator (c) at a wavelength of 230 nm to 500 nm, and a maximum absorption wavelength λd of the cationic polymerization initiator (d) at a wavelength of 260 nm to 500 nm satisfy Equation (3) below:

λd−λc≧30 nm Equation(3).

[8] The polarizing plate protective film of any one of [1] to [7], wherein the composition for forming the hard coat layer further contains (f) UV absorber.

[9] The polarizing plate protective film of [8], wherein a maximum absorption wavelength k of the radical polymerization initiator (c) at a wavelength of 230 nm to 500 nm, a maximum absorption wavelength λd of the cationic polymerization initiator (d) at the wavelength of 260 nm to 500 nm, and a maximum absorption wavelength λf of the UV absorber (f) at a wavelength of 230 nm to 500 nm satisfy Equations (3) and (4) below:

λd−λc≧30 nm Equation (3); and

λf−λd≧60 nm Equation (4).

[10] The polarizing plate protective film of any one of [1] to [9],

wherein the cellulose acylate film contains a compound represented by Formula I below:

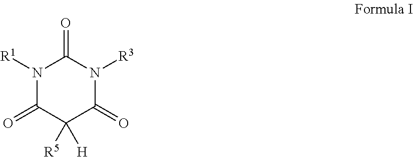

wherein in Formula I, R¹, R³, and R⁵ each independently represent a hydrogen atom, an alkyl group, a cycloalkyl group, an alkenyl group, or an aromatic group, and the alkyl group, the cycloalkyl group, the alkenyl group, and the aromatic group optionally have a substituent, provided that any one of R¹, R³, and R⁵ is an alkyl group or cycloalkyl group substituted with a group having a cyclic structure, and the number of the cyclic structure present in R¹, R³, and R⁵ is 3 or more in total.

[11]A polarizing plate including a polarizer and at least one of the polarizing plate protective films of any one of [1] to [10].

[12]A liquid crystal display device including a liquid crystal cell, and the polarizing plate of [11] disposed on at least one surface of the liquid crystal cell,

wherein the polarizing plate protective film is disposed on the outermost surface of the liquid crystal display device.

[13]A method for preparing a polarizing plate protective film including a hard coat layer having a film thickness of 3 μm to 10 μm on at least one surface of a cellulose acylate film having a thickness of 15 μm to 40 μm, wherein the polarizing plate protective film has a WVTR_{A} of 300 g/m²/day or less and a ratio WVTR_{A}/WVTR_{B} of 0.6 to 1.0 when a water vapor transmission rate under environments of a temperature of 40° C. and a relative humidity of 90% is defined as WVTR_{A} and a water vapor transmission rate under environments of a temperature of 40° C. and a relative humidity of 90% after being exposed to the environments of a temperature of 85° C. and a relative humidity of 85% for 24 hours is defined as WVTR_{B}, the method including:

applying, on at least one surface of the cellulose acylate film having a thickness of 15 μm to 40 μm, a composition for forming a hard coat layer containing:

(a) a compound having at least one alicyclic epoxy group in the molecule;

(b) a compound having three or more ethylenically unsaturated double bond groups in the molecule;

(c) a radical polymerization initiator; and

(d) a cationic polymerization initiator,

drying and ultraviolet-curing the composition,

wherein the ultraviolet-curing of the composition is a process in which UV rays are irradiated by setting a film-surface temperature to 40° C. or less and an irradiation dose to 30 mJ/cm² or more, and then irradiated by setting a film-surface temperature of 50° C. or more and an irradiation dose to 200 mJ/cm² or more.

According to the present invention, it is possible to is to provide a polarizing plate protective film which is low water vapor-permeable and excellent in surface hardness, and has excellent polarizing plate durability even under a rigorous wet heat environment, and a preparation method thereof. Further, according to the present invention, it is possible to provide a polarizing plate and an image display device, which use the polarizing plate protective film.

### DETAILED DESCRIPTION OF EXEMPLARY EMBODIMENTS

The constituent requirements to be described below may be described in some cases based on representative embodiments of the present invention, but the present invention is not limited to these embodiments. Meanwhile, the numerical range expressed by using “to” in the present specification means a range including the numerical values described before and after “to” as the lower limit value and the upper limit value. The term “acrylic resin” means a resin obtained by polymerizing methacrylic acid or derivatives of methacrylic acid, and a resin containing the derivatives thereof. In addition, unless otherwise specifically limited, the term “(meth)acrylate” indicates acrylate and methacrylate, and the term “(meth)acryl” indicates acryl and methacryl.

<Polarizing Plate Protective Film>

The polarizing plate protective film of the present invention is a polarizing plate protective film including a hard coat layer having a film thickness of 3 μm to 10 μm on at least one surface of a cellulose acylate film having a thickness of 15 μm to 40 μm, in which the hard coat layer is a layer formed by curing a composition for forming a hard coat layer, which includes the following a) to d), and the polarizing plate protective film has a WVTR_{A} of 300 g/m²/day or less and a ratio WVTR_{A}/WVTR_{B} of 0.6 to 1.0 when a water vapor transmission rate under environments of a temperature of 40° C. and a relative humidity of 90% is defined as WVTR_{A} and a water vapor transmission rate under environments of a temperature of 40° C. and a relative humidity of 90% after being exposed to the environments of a temperature of 85° C. and a relative humidity of 85% for 24 hours is defined as WVTR_{B}.

a) A compound having at least one alicyclic epoxy group in the molecule

b) A compound having three or more ethylenically unsaturated double bond groups in the molecule

c) A radical polymerization initiator

d) A cationic polymerization initiator

In the polarizing plate protective film of the present invention, the water vapor transmission rate (WVTR_{A}) under environments of a temperature of 40° C. and a relative humidity of 90% is 300 g/m²/day, preferably less than 300 g/m²/day, more preferably less than 230 g/m²/day, and even more preferably less than 200 g/m²/day.

Furthermore, in the polarizing plate protective film of the present invention, the ratio WVTR_{A} to the water vapor transmission rate (WVTR_{B}) under environments of a temperature of 40° C. and a relative humidity of 90% after being exposed to the environments of a temperature of 85° C. and a relative humidity of 85% for 24 hours (WVTR_{A}/WVTR_{B}) is 0.6 to 1.0, preferably 0.7 to 1.0, and more preferably 0.75 to 1.0. A polarizing plate protective film having excellent durability may be obtained by setting WVTR_{A} and WVTR_{A}/WVTR_{B} to the aforementioned ranges.

The present inventors have found that when a polarizing plate protective film having a hard coat layer is used for a polarizing plate, it is important for not only WVTR_{A} but also WVTR_{A}/WVTR_{B} to satisfy the aforementioned ranges under rigorous wet heat environments. The present inventors have assumed that when WVTR_{A}/WVTR_{B} is less than 0.6, under high temperature and high humid environments, the polarizer (typically PVA) deteriorates due to absorption, and components in the hard coat layer move to the polarizer, and thus cause deterioration of the polarizer.

[Hard Coat Layer]

The film thickness of the hard coat layer in the polarizing plate protective film of the present invention is 3 μm to 10 μm, and more preferably 5 μm to 8 μm. By setting the film thickness to the aforementioned range, a balance between surface hardness and water vapor transmission rate may be made. When the film thickness is 3 μm or more, the water vapor transmission rate of the film may be reduced. Further, by setting the film thickness to 10 μm or less, deterioration in brittleness may be prevented.

(Composition for Forming Hard Coat Layer)

The composition for forming the hard coat layer in the present invention at least includes the following a) to d). Accordingly, the water vapor transmission rate of the hard coat layer obtained may be reduced. In addition, in order to reduce the water vapor transmission rate, it is preferred to add (e) inorganic particles reactive with an epoxy group or an ethylenically unsaturated double bond group and having an average particle diameter of 10 nm to 100 nm in an amount of 5 mass % to 40 mass % based on the total solid content in the composition to the composition for forming the hard coat layer. This is because the water vapor permeation route length is prolonged by inorganic particles, and thus the water vapor transmission rate may be reduced. Furthermore, by having reactivity with the ethylenically unsaturated double bond group, the stability of the water vapor transmission rate may be enhanced.

When (a) inorganic particles are added to the composition for forming the hard coat layer, the addition amount is more preferably 5 mass % to 40 mass % based on the total solid content in the composition.

[(a) Compound Having at Least One Alicyclic Epoxy Group in Molecule]

(a) A compound having at least one alicyclic epoxy group in the molecule to be contained in the composition for forming the hard coat layer according to the present invention will be described. Hereinafter, (a) a compound having at least one alicyclic epoxy group in the molecule is also referred to as “Compound (a)”.

It is assumed that the composition for forming the hard coat layer may contain a compound having an alicyclic epoxy group to form a dense film, thereby reducing the water vapor transmission rate. As a specific compound of Compound (a), it is preferred to use the following compound (a1) or compound (a2).

One of the preferred embodiments of Compound (a) is a compound having one alicyclic epoxy group and one ethylenically unsaturated double bond group in the molecule as a compound represented by Formula (1) below. The water vapor transmission rate may be reduced by having one alicyclic epoxy group in the molecule, and the stability of the water vapor transmission rate may be imparted by having one ethylenically unsaturated double bond group in the molecule.

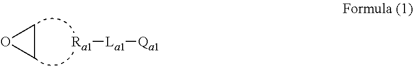

In Formula (1), Rₐ₁ represents a monocyclic hydrocarbon, or a crosslinked hydrocarbon, Lₐ₁ represents a single bond or a divalent linking group, and Qₐ₁ represents an ethylenically unsaturated double bond group.

Examples of the ethylenically unsaturated double bond group represented by Qₐ₁ include a polymerizable functional group such as a (meth)acryloyl group, a vinyl group, a vinyl group, a styryl group and, an allyl group, and among them, a (meth)acryloyl group and —C(O)OCH═CH₂, and (meth)acryloyl group is particularly preferred. It is possible to maintain high hardness by having the ethylenically unsaturated double bond group, and WVTR_{A}/WVTR_{B} may be set to 0.6 or more.

The number of each of alicyclic epoxy groups and ethylenically unsaturated double bond groups is preferably 1. When the number of each functional group is 1, on the whole, there is a tendency that the molecular weight is decreased, the water vapor transmission rate is decreased, and the surface hardness is increased.

The molecular weight of Compound (a1) is 300 or less, but preferably 200 or less, and more preferably 200 or less.

Further, from the viewpoint of suppressing volatilization when the hard coat layer is formed, the molecular weight of Compound (a1) is preferably 100 or more, and more preferably 150 or more.

When Rₐ₁ in Formula (1) is a monocyclic hydrocarbon, an alicyclic hydrocarbon is preferred, and among them, an alicyclic group having 4 to 10 carbon atoms is more preferred, an alicyclic group having 5 to 7 carbon atoms is even more preferred, and an alicyclic group having 6 carbon atoms is particularly preferred. Specifically, a cyclobutyl group, a cyclopentyl group, a cyclohexyl group, and a cycloheptyl group are preferred, and a cyclohexyl group is particularly preferred.

When Rₐ₁ in Formula (1) is a crosslinked hydrocarbon, a bicyclic crosslinkage (bicyclo ring) and a tricyclic crosslinkage (tricyclo ring) are preferred, and examples thereof include a crosslinked hydrocarbon having 5 to 20 carbon atoms, and a norbonyl group, a bornyl group, an isobornyl group, a tricyclodecyl group, a dicyclopentenyl group, a dicyclopentanyl group, a tricyclopentenyl group, and a tricyclopentanyl group, an adamantyl group, a lower alkyl group-substituted adamantyl group, and the like.

When Lₐ₁ in Formula (1) represents a divalent linking group, a divalent aliphatic hydrocarbon group is preferred. As the divalent aliphatic hydrocarbon group, the number of carbon atoms thereof is preferably 1 to 6, more preferably 1 to 3, and even more preferably 1. As the divalent aliphatic hydrocarbon group, a straight-chain, branched, or cyclic alkylene group is preferred, a straight-chain or branched alkylene group is more preferred, and a straight-chain alkylene group is even more preferred.

As a specific example of Compound (a1), the compound is not particularly limited as long as the compound is a compound having an alicyclic epoxy group and an ethylenically unsaturated double bond group in the molecule and having a molecular weight of 300 or less, and it is possible to use a compound described in paragraph no. [0015] of Japanese Patent Laid-Open Publication No. H10-17614 or represented by the Formula (1A) or (1B) below, 1,2-epoxy-4-vinylcyclohexane, and the like.

Among them, the compound represented by Formula (1A) or (1B) below is more preferred, and the compound represented by Formula (1A) below, which has a lower molecular weight, is even more preferred.

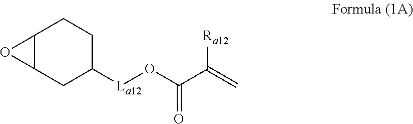

In Formula (1A), Rₐ₁₂ represents a hydrogen atom or a methyl group, and Lₐ₁₂ represents a divalent aliphatic hydrocarbon group having 1 to 6 carbon atoms.

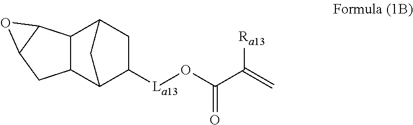

In Formula (1B), Rₐ₁₃ represents a hydrogen atom or a methyl group, and Lₐ₁₃ represents a divalent aliphatic hydrocarbon group having 1 to 3 carbon atoms.

The divalent aliphatic hydrocarbon group of Lₐ₁₂ in Formula (1A) has 1 to 6 carbon atoms, preferably 1 to 3 carbon atoms, and even more preferably 1 carbon atom (3,4-epoxycyclohexylmethyl (meth)acrylate). In addition, the divalent aliphatic hydrocarbon group of Lₐ₁₃ in Formula (1B) has 1 to 3 carbon atoms, and more preferably 1 carbon atom. As the divalent aliphatic hydrocarbon group, a straight-chain, branched, or cyclic alkylene group is preferred, a straight-chain or branched alkylene group is more preferred, and a straight-chain alkylene group is even more preferred.

Meanwhile, as the compound represented by Formula (1A) or (1B), an isomer thereof is also preferred.

Another preferred embodiment of Compound (a) is a compound (a2) having a repeating unit represented by Formula (2) below and a weight average molecular weight of 1.500 or more.

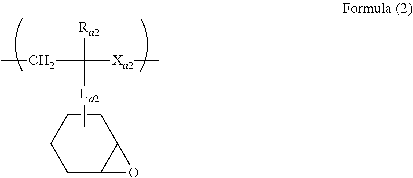

In Formula (2), Xₐ₂ represents a single bond, or a hydrogen atom, an alkylene group which may have a substituent, an arylene group which may have a substituent, an aralkylene group which may have a substituent, an ester bond, a carbonyl bond, —NH—, or a linking group composed of a combination thereof.

When Xₐ₂ represents an alkylene group, the alkylene group may be a straight-chain, branched, or cyclic alkylene group. As the alkylene group, an alkylene group having 1 to 6 carbon atoms is preferred, and an alkylene group having 1 or 3 carbon atoms is more preferred. As the alkylene group, specifically, a methylene group, an ethylene group, a propylene group, and a cyclohexylene group are preferred.

When Xₐ₂ represents an arylene group, an arylene group having 6 to 18 carbon atoms is preferred, and an arylene group having 6 to 12 carbon atoms is more preferred. As the arylene group, specifically, a phenylene group and a naphthylene group are preferred.

When Xₐ₂ represents an aralkylene group, an aralkylene group having 7 to 19 carbon atoms is preferred, and an aralkylene group having 7 to 13 carbon atoms is more preferred. As the aralkylene group, an alkylene group composed of preferred ranges of the alkylene group and preferred ranges of the arylene group is preferred.

Furthermore, Xₐ₂ may be a linking group composed of a combination of the aforementioned linking groups, and examples of the linking group composed of the combination include a linking group composed of a combination of an ester bond and an alkylene group, a linking group composed of a combination of an arylene group, an ester bond, and an alkylene group, a linking group composed of a combination of an alkylene group and ether bond, a linking group composed of a combination of a carbonyl bond, —NH— an alkylene group, and an ether bond, and the like.

As X, a sing bond is most preferred.

In Formula (2), Lₐ₂ represents a single bond, or an alkylene group which may have a substituent, an arylene group which may have a substituent, an aralkylene group which may have a substituent, an ester bond, an ether bond, a carbonyl bond, —NH—, or a linking group composed of a combination thereof.

When Xₐ₂ represents an alkylene group, the alkylene group may be a straight-chain, branched, or cyclic alkylene group. As the alkylene group, an alkylene group having 1 to 6 carbon atoms is preferred, and an alkylene group having 1 or 3 carbon atoms is more preferred. As the alkylene group, specifically, a methylene group, an ethylene group, a propylene group, and a cyclohexylene group are preferred.

When Lₐ₂ represents an arylene group, an arylene group having 6 to 18 carbon atoms is preferred, and an arylene group having 6 to 12 carbon atoms is more preferred. As the arylene group, specifically, a phenylene group and a naphthylene group are preferred.

When Lₐ₂ represents an aralkylene group, an aralkylene group having 7 to 19 carbon atoms is preferred, and an aralkylene group having 7 to 13 carbon atoms is more preferred. As the aralkylene group, an alkylene group composed of preferred ranges of the alkylene group and preferred ranges of the arylene group is preferred.

Further, Lₐ₂ may be a linking group composed of a combination of the aforementioned linking groups, and examples of the linking group composed of the combination include a linking group composed of a combination of an ester bond and an alkylene group, a linking group composed of a combination of an arylene group, an ester bond, and an alkylene group, a linking group composed of a combination of an alkylene group and ether bond, a linking group composed of a combination of a carbonyl bond, —NH— an alkylene group, and an ether bond, and the like.

As Lₐ₂, an ester bond, an ether bond, —CONH—, an alkylene group, an arylene group, or a linking group composed of a combination thereof is preferred.

In Formula (2), Rₐ₂ is preferably a hydrogen atom or a methyl group.

Specific examples of the repeating unit represented by Formula (2) will be shown below, but the repeating unit is not limited thereto.

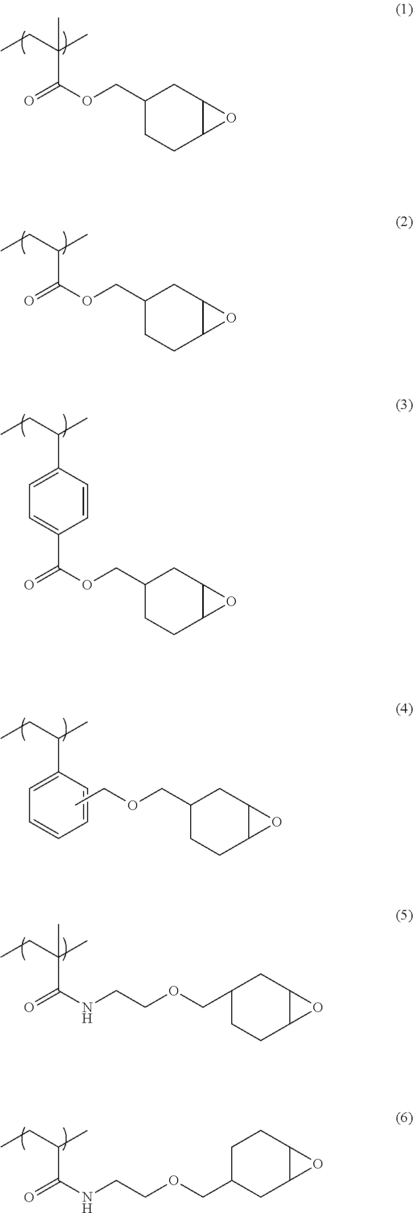

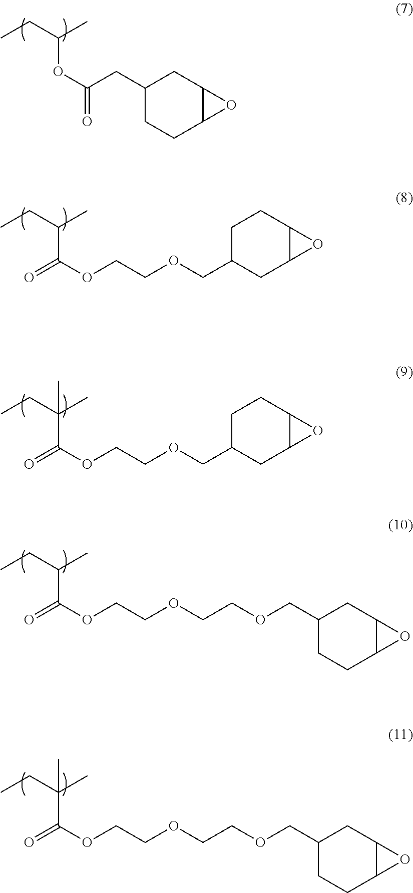

The weight average molecular weight (MW) of Compound (a2) is 1,500 or more, preferably 3,000 or more, more preferably 10,000 or more, and even more preferably 50,000 or more. In addition, the weight average molecular weight of Compound (a) is preferably 1,000,000 or less, more preferably 500,000 or less, and even more preferably 250,000 or less.

By setting the weight average molecular weight of Compound (a2) to 1,500 or more, WVTR_{A}/WVTR_{B} becomes 0.6 or more, and thus a polarizing plate protective film having excellent durability may be prepared.

The weight average molecular weight of Compound (a2) is defined as a value in terms of polystyrene by gel permeation chromatography (GPC) measurement (solvent: tetrahydrofuran, column: column: TSKgel SuperHZM-H, TSKgel SuperHZ4000, and TSKgel SuperHZ200 manufactured by TOSOH CORPORATION, column temperature: 40° C., flow rate: 1.0 mL/min, and detector: RI).

Compound (a2) may have one of the repeating units represented by Formula (2), or two or more thereof. In addition, Compound (a2) may have a repeating unit other than the repeating unit represented by Formula (2) within the range not impairing the effects of the present invention. As a technique of introducing the repeating unit other than Formula (2), a technique of introducing the repeating unit by copolymerizing the corresponding monomer is preferred.

When the repeating unit other than Formula (2) is introduced by copolymerizing a corresponding vinyl monomer, examples of a monomer preferably used include esters or amides (for example, N-i-propylacrylamide, N-n-butylacrylamide, N-t-butylacrylamide, N,N-dimethylacrylamide, N-methylmethacrylamide, acrylamide, 2-acrylamide-2-methylpropanesulfonic acid, acrylamidopropyltrimethylammonium chloride, methacrylamide, diacetoneacrylamide, acryloylmorpholine, N-methylolacryloamide, N-methylolmethacrylamide, methyl acrylate, ethyl acrylate, hydroxyethyl acrylate, n-propyl acrylate, i-propyl acrylate, 2-hydroxypropyl acrylate, 2-methyl-2-nitropropyl acrylate, n-butyl acrylate, i-butyl acrylate, t-butyl acrylate, t-pentyl acrylate, 2-methoxyethyl acrylate, 2-ethoxyethyl acrylate, 2-methoxymethoxyethyl acrylate, 2,2,2-trifluoroethyl acrylate, 2,2-dimethylbutyl acrylate, 3-methoxybutyl acrylate, ethyl carbitol acrylate, phenoxyethyl acrylate, n-pentyl acrylate, 3-pentyl acrylate, octafluoropentyl acrylate, n-hexyl acrylate, cyclohexyl acrylate, cyclopentyl acrylate, cetyl acrylate, benzyl acrylate, n-octyl acrylate, 2-ethylhexyl acrylate, 4-methyl-2-propylpentyl acrylate, heptadecafluorodecyl acrylate, n-octadecyl acrylate, methyl methacrylate, 2,2,2-trifluoroethyl methacrylate, tetrafluoropropyl methacrylate, hexafluoropropyl methacrylate, hydroxyethyl methacrylate, 2-hydroxypropyl methacrylate, n-butyl methacrylate, i-butyl methacrylate, sec-butyl methacrylate, n-octyl methacrylate, 2-ethylhexyl methacrylate, 2-methoxyethyl methacrylate, 2-ethoxyethyl methacrylate, benzyl methacrylate, heptadecafluorodecyl methacrylate, n-octadecyl methacrylate, 2-isobornyl methacrylate, 2-norbornylmethyl methacrylate, 5-norbornen-2-ylmethyl methacrylate, 3-methyl-2-norbornylmethyl methacrylate, dimethylaminoethyl methacrylate, and the like) derived from acrylic acid or α-alkylacrylic acids (for example methacrylic acid, and the like), acrylic acid or α-alkyl acrylic acid (acrylic acid, methacrylic acid, itaconic acid, and the like), vinyl esters (for example, vinyl acetate), esters (dimethyl maleate, dibutyl maleate, diethyl fumarate, and the like) derived from maleic acid or fumaric acid, maleimides (N-phenylmaleimide, and the like), maleic acid, fumaric acid, sodium salts of p-styrene sulfonic acid, acrylonitrile, methacrylonitrile, dienes (for example, butadiene, cyclopentadiene, and isoprene), aromatic vinyl compounds (for example, styrene, p-chlorostyrene, t-butylstyrene, a-methylstyrene, and sodium styrenesulfonate), N-vinylpyrrolidone, N-vinyloxazolidone, N-vinylsuccinimide, N-vinylformamide, N-vinyl-N-methylformamide, N-vinylacetamide, N-vinyl-N-methylacetamide, 1-vinylimidazole, 4-vinylpyridine, vinylsulfonic acid, sodium vinylsulfonate, sodium allylsulfonate, sodium metallylsulfonate, vinylidene chloride, vinyl alkyl ethers (for example, methyl vinyl ether), ethylene, propylene, 1-butene, isobutene, and the like. These vinyl monomers may be used in combination of two or more thereof. As vinyl monomers other than the aforementioned vinyl monomers, those described in Research Disclosure No. 1955 (July, 1980) may be used. In the present invention, esters and amides, derived from acrylic acid or methacrylic acid, and aromatic vinyl compounds are vinyl monomers which are particularly preferably used.

As the repeating unit other than Formula (2), a repeating unit having a reactive group other than an epoxy group may also be introduced. In particular, when hardness of the hard coat layer wants to be increased, or when interlayer adhesion wants to be improved in the case of using a separate functional layer on a substrate or a hard coat, a technique of using a compound including a reactive group other than an epoxy group is suitable. As a method of introducing a repeating unit having a reactive group other than an epoxy group, a technique of copolymerizing a corresponding vinyl monomer (hereinafter, referred to as “a reactive monomer”.) is simple and preferred.

Hereinafter, specific examples of the reactive monomer will be described, but the present invention is not limited thereto.

Examples thereof include hydroxyl group-containing vinyl monomers (for example, hydroxyethyl acrylate, hydroxyethyl methacrylate, allylalcohol, hydroxypropyl acrylate, hydroxypropyl methacrylate, and the like), isocyanate group-containing vinyl monomers (for example, isocyanatoethyl acrylate, isocyanatoethyl methacrylate, and the like), N-methylol group-containing vinyl monomers (for example, N-methylol acrylamide, N-methylol methacrylamide, and the like), carboxyl group-containing vinyl monomers (for example, acrylic acid, methacrylic acid, itaconic acid, carboxyethyl acrylate, and vinyl benzoate), alkylhalide-containing vinyl monomers (for example, chloromethyl styrene and 2-hydroxy-3-chloropropyl methacrylate), acid anhydride-containing vinyl monomers (for example, maleic anhydride), formyl group-containing vinyl monomers (for example, acrolein and methacrolein), sulfinic acid-containing vinyl monomers (for example, potassium styrenesulfonate), active methylene-containing vinyl monomers (for example, acetoacetoxyethyl methacrylate), amino group-containing monomers (for example, allylamine), alkoxysilyl group-containing monomers (for example, methacryloyloxypropyltrimethoxysilane and acryloyloxypropyltrimethoxysilane), and the like.

When the repeating unit other than Formula (2) does not have a crosslinked reactive group, if the content thereof is excessively high, hardness is decreased, and when the repeating unit has a crosslinked reactive group, hardness may be maintained in some cases, but curing shrinkage may increase, or brittleness may deteriorate in some cases. In particular, when the crosslinking reaction accompanies a decrease in molecular weight, such as dehydration or dealcoholation, just as in the case where a copolymer of an alkoxysilyl group-containing monomer (for example, methacryloyloxypropyl trimethoxysilane) and a repeating unit represented by Formula (2) is used, curing shrinkage easily increases. When a repeating unit having a crosslinkably reactive group, with which the crosslinking reaction progresses accompanying a decrease in molecular weight, is introduced into a compound including the repeating unit represented by Formula (2) of the present invention, a ratio of the repeating unit represented by Formula (2) in the compound is preferably 70 mass % to 99 mass %, more preferably 80 mass % to 99 mass %, and particularly preferably 90 mass % to 99 mass %, with respect to the mass of the compound.

When the total solid content of the composition for forming the hard coat layer in the present invention is set to 100 mass %, Compound (a) is contained in an amount of preferably 10 mass % to 40 mass % and more preferably 15 mass % to 30 mass %. When the content is 10 mass % or more, the effect of decreasing water vapor transmission rate is sufficient. When the content is 40 mass % or less, surface hardness increases.

[(b) Compound Having Three or More Ethylenically Unsaturated Double Bond Groups in Molecule]

(b) A compound having three or more ethylenically unsaturated double bond groups in the molecule to be contained in the composition for forming the hard coat in the present invention will be described. Hereinafter, (b) a compound having three or more ethylenically unsaturated double bond groups in the molecule is also referred to as “Compound (b)”.

Compound (b) may exhibit high hardness by having three or more ethylenically unsaturated double bond groups in the molecule.

Examples of Compound (b) include esters of polyhydric alcohol and (meth)acrylic acid, vinyl benzene and derivatives thereof, vinylsulfones, (meth)acrylamide, and the like. Among them, a compound having three or more (meth)acryloyl groups is preferred from the viewpoint of hardness, and examples thereof include an acrylate-based compound which forms a cured product having high hardness widely used in the art. Examples of these compounds include esters of polyhydric alcohol and (meth)acrylic acid {for example, pentaerythritoltetra (meth)acrylate, pentaerythritoltri (meth)acrylate, trimethylolpropane tri (meth)acrylate, EO-modified trimethylolpropane tri (meth)acrylate, PO-modified trimethylolpropane tri (meth)acrylate, EO-modified phosphoric acid (meth)acrylate, trimethylolethane tri (meth)acrylate, ditrimethylolpropane tetra (meth)acrylate, dipentaerythritol tetra (meth)acrylate, dipentaerythritol penta (meth)acrylate, dipentaerythritol hexa (meth)acrylate, pentaerythritol hexa (meth)acrylate, 1,2,3-chlorohexane tetramethacrylate, polyurethane polyacrylate, polyester polyacrylate, caprolactone-modified tris (acryloxyethyl)isocyanurate, and the like.

Examples of a specific compound of the polyfunctional acrylate-based compounds having three or more (meth)acryloyl groups include esterified products of a polyol and a (meth)acrylic acid, such as KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60 and KAYARAD GPO-303 manufactured by Nippon Kayaku Co., Ltd., and V#400 and V#36095D manufactured by OSAKA ORGANIC CHEMICAL INDUSTRY LTD. Furthermore, it is also possible to suitably use trifunctional or higher urethane acrylate compounds such as SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310EA. SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, SHIKOH UV-2250EA, SHIKOH UV-2750B (manufactured by The Nippon Synthetic Chemical Industry Co., Ltd.), UL-503LN (manufactured by KYOEISHA CHEMICAL Co., Ltd.), UNIDIC 17-806, UNIDIC 17-813, UNIDIC V-4030, UNIDIC V-4000BA (manufactured by DIC Corporation), EB-1290K, EB-220, EB-5129, EB-1830, EB-4358 (manufactured by Daicel-UCB Company, Ltd.), HI-COAP AU-2010, AU-2020 (manufactured by TOKUSHIKI Co. Ltd.), Aronix M-1960 (manufactured by TOAGOSEI CO., LTD.), Artesin UN-3320HA, UN-3320HC, UN-3320HS, UN-904, and HDP-4T, and trifunctional or higher polyester compounds such as Aronix M-8100, M-8030 and M-9050 (manufactured by TOAGOSEI CO., LTD.), and the like.

It is preferred that Compound (b) does not have an epoxy group in the molecule.

Compound (b) may be used either alone or in combination of two or more thereof.

When the total solid content of the composition for forming the hard coat layer in the present invention is set to 100 mass %, it is preferred that Compound (b) is contained in an amount of 35 mass % or more. The surface hardness may be maintained by setting the content to 35 mass % or more. Further, the content of Compound (b) is preferably 89.9 mass % or less and more preferably 50 mass % to 80 mass % with respect to the total solid content of the composition for forming the hard coat layer. It is assumed that by setting Compound (a) and Compound (b) to the aforementioned ratios, Compound (a) and Compound (b) form a network structure which is dense and has high wet heat stability, and thus excellent low water vapor permeability may be obtained.

[(c) Radical Polymerization Initiator]

(C) A radical polymerization initiator contained in the composition for forming the hard coat layer in the present invention will be described. Hereinafter, (c) the radical polymerization initiator will also be referred to as “(c) Component”.

A compound having ethylenically unsaturated groups may be polymerized by irradiating ionized radiation or heating in the presence of a photoradical polymerization initiator or a heat radical polymerization initiator.

As the photo and heat polymerization initiators, commercially available compounds may be used, and these compounds are described in “Latest UV Curing Technologies” {p. 159, publisher, Kazuhiro Takausu, publishing house; TECHNICAL INFORMATION INSTITUTE CO. LTD., and published in 1991}, or the brochure from BASF.

As (C) Component, specifically, it is possible to use alkyl phenone-based photopolymerization initiators (Irgacure651, Irgacure184, DAROCURE1173, Irgacure2959, Irgacure127, DAROCURE MBF, Irgacure907, Irgacure369, and Irgacure379EG), acyphosphineoxide-based photopolymerization initiator (Irgacure819 and LUCIRINTPO), others (Irgacure784, Irgacure OXE01, Irgacure OXE02, and Irgacure754), and the like.

When the total solid content of the composition for forming the hard coat layer is set to 100 mass %, the amount of (C) Component added is preferably 0.1 mass % to 10 mass %, and more preferably 1 mass % to 5 mass %. When the addition amount is 0.1 mass % or more, polymerization sufficiently proceeds, and thus hardness of the hard coat layer is improved. Meanwhile, when the amount is 10 mass % or less, UV rays reach the inside of the film, and thus, hardness of the hard coat layer is improved. These radical initiators may be used either alone or in combination of a plurality thereof.

[(d) Cationic Polymerization Initiator]

(C) A cationic polymerization initiator contained in the composition for forming the hard coat layer in the present invention will be described. Hereinafter, (d) the cationic polymerization initiator will also be referred to as “(d) Component”.

Examples of (d) Component include publicly-known compounds such as a photoinitiator for cationic photopolymerization, a photodecoloring agent for dyes, a photodiscoloring agent, or a photoacid generating agent used in microresists, and the like, mixtures thereof, and the like.

Examples thereof include onium compounds, organo halogen compounds, and disulfone compounds. Specific examples of the organo halogen compounds and the disulfone compounds include those described in the compounds which generate the radicals.

Examples of the onium compounds include diazonium salts, ammonium salts, iminium salts, phosphonium salts, iodonium salts, sulfonium salts, arsonium salts, selenonium salts, and the like, and examples thereof include compounds described in, for example, paragraph nos. [0058] and [0059] of Japanese Patent Laid-Open Publication No. 2002-29162, and the like.

In the present invention, examples of the cationic polymerization initiator particularly suitably used include onium salts, and diazonium salts, iodonium salts, sulfonium salts, and iminium salts are preferred from the viewpoint of optical sensitivity of the photopolymerization initiation, material stability of the compounds, and the like, and among them, iodonium salts are most preferred from the viewpoint of light fastness.

In the present invention, specific examples of onium salts which may be suitably used include, for example, acylated sulfonium salts described in the paragraph no. [0035] of Japanese Patent Laid-Open Publication No. H9-268205, diaryliodonium salts or triarylsulfonium salts described in paragraph nos. [0010] and [0011] of Japanese Patent Laid-Open Publication No. 2000-71366, sulfonium salts of thiobenzoic acid S-phenyl ester described in paragraph no. [0017] of Japanese Patent Laid-Open Publication No. 2001-288205, onium salts described in paragraph nos. [0030] to [0033] of Japanese Patent Laid-Open Publication No. 2001-133696, and the like.

Other examples thereof include compounds such as organo metal/organo halogenide disclosed in paragraphs [0059] to [0062] of JP-A 2002-29162, photoacid generating agent having o-nitrobenzyl type protecting group, compounds generating sulfonic acid via photodecomposition (imino sulfonate and the like).

As a specific compound of iodonium salt-based cationic polymerization initiator, it is possible to use B2380 (manufactured by Tokyo Chemical Industry Co., Ltd.), BBI-102(Midori Kagaku Co., Ltd.), WPI-113 (manufactured by Wako Pure Chemical Industries, Ltd.), WPI-124 (manufactured by Wako Pure Chemical Industries, Ltd.), WPI-169 (manufactured by Wako Pure Chemical Industries, Ltd.), WPI-170 (manufactured by Wako Pure Chemical Industries, Ltd.), and DTBPI-PFBS (manufactured by Toyo Gosei Co., Ltd.).

(d) Components may be used either alone or in combination of two or more thereof.

When the total solid content of the composition for forming the hard coat layer in the present invention is set to 100 mass %, (d) Component is added in a range of preferably 0.1 mass % to 10 mass %, and more preferably at a ratio of 0.5 mass % to 3.0 mass %. When the addition amount is adjusted to the aforementioned range, the amount is preferred from the viewpoint of stability of the curable composition, polymerization reactivity, and the like.

It is preferred that the maximum absorption wavelength λc at the wavelength of 230 nm to 500 nm of (c) Component and the maximum absorption wavelength λd at the wavelength of 260 nm to 500 nm of (d) Component satisfy the relationship of Equation (3) below.

λd−λc≧30 nm Equation (3):

λd−λc is preferably 30 nm or more, and more preferably 35 nm or more. By designing the absorption wavelengths of (c) Component and (d) Component in the aforementioned ranges, the applied film may be efficiently cured, and the stability of water vapor of water vapor permeability may be enhanced.

[(e) Inorganic Particles Reactive with Epoxy Group or Ethylenically Unsaturated Double Bond Group]

It is preferred that the composition for forming the hard coat layer in the present invention additionally contain (e) inorganic particles reactive with an epoxy group or an ethylenically unsaturated double bond group. Hereinafter, (e) inorganic particles reactive with an epoxy group or an ethylenically unsaturated double bond will also be referred to as “(e) Component”.

The inorganic particles are added to the composition for forming the hard coat layer to prolong the water vapor permeation route length, thereby reducing the water vapor transmission rate. In addition, by imparting a group reactive with an epoxy group or an ethylenically unsaturated double bond group to the inorganic particle surface, stability of the water vapor transmission rate may be improved, thereby increasing the WVTR_{A}/WVTR_{B}.

Examples of the inorganic particles include silica particles, titanium dioxide particles, zirconium oxide particles, aluminum oxide particles, and the like. Among them, silica particles are preferred.

In general, since the inorganic particles have low affinity for organic components such as polyfunctional vinyl monomers, aggregates may be formed or a cured layer after being cured may be cracked, and thus easily broken, in some cases. Accordingly, it is preferred that as (e) Component in the present invention, the inorganic particle surface is treated with a surface modifying agent including an organic segment in order to enhance the affinity of inorganic particles for organic components.

It is preferred that the surface modifying agent has a functional group which may form a bond with inorganic particles or be adsorbed to inorganic particles, and a functional group having high affinity for organic components in the same molecule. As the surface modifying agent having the functional group which may be bonded to or adsorbed to inorganic particles, preferred is a metal alkoxide surface modifying agent such as silane, aluminum, titanium, and zirconium, or a surface modifying agent having an anionic group such as a phosphoric acid group, a sulfuric acid group, a sulfonic acid group, and a carboxylic acid group. Furthermore, as a functional group having high affinity for organic components, a functional group that has just the same hydrophilicity/hydrophobicity for organic components may be used, but a functional group which may be chemically bonded to organic components is preferred, and an ethylenically unsaturated double bond group or a ring-opening polymerizable group is particularly preferred.

A preferred inorganic particle surface modifying agent in the present invention is a curable resin having metal alkoxide or an anionic group and an ethylenically unsaturated double bond group or a ring-opening polymerizable group in the same molecule. By chemically bonding the surface modifying agent to organic components, the crosslinking density of the hard coat layer may be increased, thereby enhancing the stability of water vapor transmission rate or the pencil hardness.

Representative examples of the surface modifying agents include an ethylenically unsaturated double bond-containing coupling agent, a phosphoric acid group-containing organic curable resin, a sulfuric acid group-containing organic curable resin, a carboxylic acid group-containing organic curable resin, and the like to be exemplified in the following (S−1) to (S-8).
(S-1): H₂C═C(X)COOC₃H₆Si(OCH3)₃
(S-2): H₂C═C(X)COOC₂H₄OTi(OC₂H₅)₃
(S-3): H₂C═C(X)COOC₂H₄OCOC₅H₁₀OPO(OH)₂
(S-4): (H₂C═C(X)COOC₂H₄OCOC₅H₁₀O)₂POOH
(S-5): H₂C═C(X)COOC₂H₄OSO₃H
(S-6): H₂C═C(X)COO(C₅H₁₀COO)₂H
(S-7): H₂C═C(X)COOC₅H₁₀COOH
(S-8): CH₂CH(O)CH₂OC₃H₆Si(OCH₃)₃

In (S-1) to (S-8), X represents a hydrogen atom or CH₃.

It is preferred that the surface modification of the inorganic particles is carried out in a solution. It is also possible to use a method of allowing the inorganic particles to be present with the surface modifying agent when the inorganic particles are mechanically dispersed finely, or adding and stirring the surface modifying agent after finely dispersing the inorganic particles, or performing surface modification before finely dispersing the inorganic particles (performing warming, heating after drying or pH change, if necessary), and then performing fine dispersion. As a solution for dissolving the surface modifying agent, an organic solvent having high polarity is preferred. Specific examples thereof include publicly known solvents such as alcohol, ketone, and ester.

When the total solid content of the composition for forming the hard coat layer in the present invention is set to 100 mass %, the amount of (e) Component added is preferably 5 mass % to 40 mass/o %, and more preferably 10 mass % to 30 mass %, in consideration of balance between hardness and brittleness of the coating film.

Further, the size (average primary particle diameter) of (e) the inorganic particles is preferably 10 nm to 100 nm, and more preferably 10 nm to 60 nm. The average particle diameter of the particles may be obtained from the electron microscope photograph. When the particle diameter of the inorganic particles is excessively small, the effects of improving hardness may not be obtained, and when the particle diameter is excessively large, the large particle diameter becomes responsible for an increase in haze.

Meanwhile, it is assumed that a rigid particle network structure is formed by using a plurality of inorganic particles linked to each other in a chain shape, and thus the hardness is improved.

Specific examples of the inorganic particles include ELECOM V-8802 (spherical silica particles having an average particle size of 12 nm manufactured by JGC Corporation) or ELECOM V-8803 (deformed silica particles manufactured by JGC Corporation), MiBK-SD (spherical silica particles having an average particle size of 10 nm to 20 nm manufactured by Nissan Chemical Industries, Ltd.), MEK-AC-2140Z (spherical silica particles having an average particle size of 10 nm to 20 nm manufactured by Nissan Chemical Industries, Ltd.), MEK-AC-4130C (spherical silica particles having an average particle size of 40 nm to 50 nm manufactured by Nissan Chemical Industries, Ltd.), MiBK-SD-L (spherical silica particles having an average particle size of 40 nm to 50 nm manufactured by Nissan Chemical Industries, Ltd.), MEK-AC-5140 Z (spherical silica particles having an average particle size of 70 nm to 100 nm manufactured by Nissan Chemical Industries, Ltd.), and the like.

[(f) UV Absorber]

It is more preferred that the composition for forming the hard coat layer in the present invention additionally contains (f) a UV absorber. Hereinafter, (f) the UV absorber will also be referred to as (f) Component.

The UV absorber attributes to the improvement of durability of the polarizing plate. Particularly, in an aspect that uses the polarizing plate protective film of the present invention as a surface protective film of an image display device, the addition of a UV absorber is effective. UV absorbability may be imparted only to a transparent support, but the function deteriorates as a transparent support becomes thinner, and thus, it is preferred to impart UV absorbability to the hard coat layer as well. The UV absorber, which may be used in the present invention, is not particularly limited, and examples thereof include compounds described in paragraph nos. [0107] to [0185] of Japanese Patent Laid-Open Publication No. 2006-184874. A polymer UV absorber may also be preferably used, and particularly, the UV absorber described in Japanese Patent Laid-Open Publication No. H6-148430 is preferably used.

The amounts of (f) Component used are not the same as each other according to the type and use conditions of compound, and the like, but when the total solid content of the composition for forming the hard coat layer in the present invention is set to 100 mass %, it is preferred that (f) Component is included at a ratio of 0.1 mass % to 10 mass %.

When (c) Component, (d) Component, and (f) Component are contained in the composition for forming the hard coat layer, it is preferred that the maximum absorption wavelength λc of (C) Component at the wavelength of 230 nm to 500 nm, the maximum absorption wavelength λd of (d) Component at the wavelength of 260 nm to 500 nm, and the maximum absorption wavelength λf of (f) Component at the wavelength of 230 nm to 500 nm satisfy Equations (3) and (4) below.

λd−λc≧30 nm Equation (3)

λf−λd≧60 nm Equation (4)

Excellent water vapor transmission rate and stability may be obtained by satisfying Equations (3) and (4) even a UV absorber is added.

(Solvent)

The composition for forming the hard coat layer in the present invention may contain a solvent. As the solvent, it is possible to use various solvents selected from the viewpoint that the solvent may dissolve or disperse each component, the solvent easily becomes uniformly sheet-like in the application process and the drying process, the solvent may secure liquid preservability, the solvent has an appropriate saturated vapor pressure, and the like.

The solvents may be used in mixture of two or more thereof. In particular, from the viewpoint of drying load, it is preferred to use a solvent having a boiling temperature of 100° C. or less at room temperature under normal pressure as a main component and contain a solvent having a boiling temperature of more than 100° C. in a small amount in order to adjust the drying speed.

In the composition for forming the hard coat layer in the present invention, a solvent having a boiling temperature of 80° C. or less is contained in an amount of preferably 30 mass % to 80 mass %, and more preferably 50 mass % to 70 mass % in the entire solvent of the application composition. By setting the ratio of the solvent having a boiling temperature of 80° C. or less to the aforementioned ratio, resin components are appropriately suppressed from penetrating into a transparent support, and it is possible to suppress particles from being precipitated as the viscosity increase rate caused by the drying increases.

Examples of the solvent having a boiling temperature of 100° C. or less include hydrocarbons such as hexane (boiling temperature 68.7° C.), heptane (98.4° C.), cyclohexane (80.7° C.), and benzene (80.1° C.), halogenated hydrocarbons such as dichloromethane (39.8° C.), chloroform (61.2° C.), carbon tetrachloride (76.8° C.), 1,2-cichloroethane (83.5° C.), and trichloroethylene (87.2° C.), ethers such as diethyl ether (34.6° C.), diisopropyl ether (68.5° C.), dipropyl ether (90.5° C.), and tetrahydrofuran (66° C.), esters such as ethyl formate (54.2° C.), methyl acetate (57.8° C.), ethyl acetate (77.1° C.), and isopropyl acetate (89° C.), ketones such as acetone (56.1° C.) and 2-butanone (the same as methyl ethyl ketone (MEK), 79.6° C.), alcohols such as methanol (64.5° C.), ethanol (78.3° C.), 2-propanol (82.4° C.), and 1-propanol (97.2° C.), cyano compounds such as acetonitrile (81.6° C.) and propionitrile (97.4° C.), carbon disulfide (46.2° C.), and the like. Among them, ketones and esters are preferred, and ketones are particularly preferred. Among the ketones, 2-butanone is particularly preferred.

Examples of the solvent having a boiling temperature of more than 100° C. include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (the same as MIBK, 115.9° C.), 1-butanol (117.7° C.), N,N-dimethylformamide (153° C.). N,N-dimethylacetamide (166° C.), dimethyl sulfoxide (189° C.), and the like. Cyclohexanone and 2-methyl-4-pentanone are preferred.

(Surfactant)

It is also suitable to use various surfactants for the composition for forming a hard coat layer in the present invention. In general, the surfactant may suppress the film thickness unevenness and the like resulting from the drying variation caused by the localized distribution of the drying wind.

As the surfactant, it is specifically preferred to contain a fluorine-based surfactant or a silicone-based surfactant, and both the surfactants. In addition, it is preferred that the surfactant is an oligomer or a polymer rather than a low-molecular weight compound.

Preferred examples of the fluorine-based surfactant include a fluoroaliphatic group-containing copolymer (hereinafter, also abbreviated referred to as “a fluorine-based polymer” in some cases), and as the fluorine-based polymer, an acrylic resin including a repeating unit corresponding to the following monomer of (i) or including a repeating unit corresponding to the monomer (i) and a repeating unit corresponding to the following monomer of (ii), a methacrylic resin, and a copolymer of those monomers and a vinyl-based monomer copolymerizable with those monomer.

(i) Fluoroaliphatic Group-Containing Monomer Represented by Formula (A) below

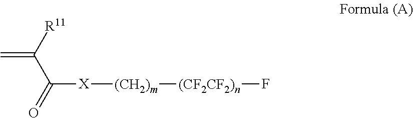

In Formula (A), R¹¹ represents a hydrogen atom or a methyl group, X represents a hydrogen atom, a sulfur atom, or —N(R¹²)—, m represents an integer of 1 to 6, and n represents an integer of 2 to 4. R¹² represents a hydrogen atom or an alkyl group having 1 to 4 carbon atoms, specifically a methyl group, a propyl group, and a butyl group, and is preferably a hydrogen atom or a methyl group. X is preferably an oxygen atom.

(ii) Monomer Copolymerizable with (i) and Represented by Formula (B) below

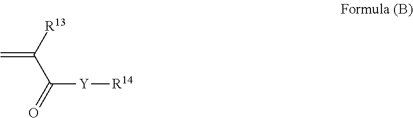

In Formula (B), R¹³ represents a hydrogen atom or a methyl group, Y represents a hydrogen atom, a sulfur atom, or —N(R¹⁵)—, and R¹⁵ represents a hydrogen atom or an alkyl group having 1 to 4 carbon atoms, specifically, a methyl group, an ethyl group, a propyl group, and a butyl group, and is preferably a hydrogen atom or a methyl group. Y is preferably an oxygen atom, —N(H)—, and —N(CH₃)—.

R¹⁴ represents a straight-chain, branched or cyclic alkyl group having 4 to 20 carbon atoms, which may have a substituent. Examples of the substituent of the alkyl group of R¹⁴ include a hydroxyl group, an alkyl carbonyl group, an aryl carbonyl group, a carboxyl group, an alkyl ether group, an aryl ether group, a halogen atom such as a fluorine atom, a chlorine atom or a bromine atom, a nitro group, a cyano group, an amino group, and the like, but the substituent is not limited thereto. As the straight-chain, branched or cyclic alkyl group having 4 to 20 carbon atoms, suitably used are a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, an eicosanyl group, and the like, which may be straight-chained or branched, a monocycloalkyl group such as a cyclohexyl group or a cycloheptyl group, and a polycyclic alkyl group such as a bicycloheptyl group, a bicyclodecyl group, a tricycloundecyl group, a tetracyclodedecyl group, an adamantyl group, a norbornyl group or a tetracyclodecyl group.

The amount of the fluoroaliphatic group-containing monomer represented by Formula (A) used in the fluorine-based polymer is in a range of 10 mol % or more, preferably 15 mol % to 70 mol %, and more preferably 20 mol % to 60 mol %, based on each monomer of the fluorine-based polymer.

The fluorine-based polymer surfactant has a mass average molecular weight of preferably 3,000 to 100,000, and more preferably 5,000 to 80,000. Furthermore, the amount of the fluorine-based polymer surfactant added is in a range of 0.001 part by mass to 5 parts by mass, preferably in a range of 0.005 part by mass to 3 parts by mass, and in a range of more preferably 0.01 part by mass to 1 part by mass, with respect to 100 parts by mass the coating liquid. When the amount of the fluorine-based polymer added is 0.001 part by mass, the effect of adding the fluorine-based polymer is sufficiently obtained, and when the amount is 5 parts by mass, the problem in that drying of the coating film is not sufficiently carried out, or performances as the coating film are adversely affected does not occur.

Examples of the preferred silicone-based compound include “X-22-174DX”, “X-22-2426”, “X-22-164C”, and “X-22-176D” (all trade names) manufactured by Shin-Etsu Chemical Co. Ltd., “FM-7725”, “FM-5521”, and “FM-6621” (all trade names) manufactured by Chisso Corporation, “DMS-U22” and “RMS-033” (all trade names) manufactured by Gelest, Inc., “SH200”, “DC 11PA”, “ST80PA”, “L7604”, “FZ-2105”, “L-7604”, “Y-7006”, and “SS-2801” (all trade names) manufactured by Dow Corning Toray Co., Ltd., “TSF400” (trade name) manufactured by Momentive Performance Materials Inc., and the like, but the compound is not limited thereto.

When the total solid content of the composition for forming the hard coat layer in the present invention is set to 100 mass %, the silicone-based surfactant is contained in an amount of preferably 0.01 mass % to 0.5 mass %, and more preferably 0.01 mass % to 0.3 mass %.

Further, it is also suitable to use a surfactant having good recoatability in the hard coat layer.

As the surfactant having good recoatability, it is possible to use a polymer a hydrophilic group in the molecule, a polymer having a perfluoroalkenyl structure having a large volume, a polymer from which a fluorine-containing group is discharged by irradiating UV rays, and the like. Specific examples thereof include LE-605 and LE-607 (manufactured by KYOEISHA CHEMICAL Co., Ltd.), Megafac TF-1939, TF-1940, TF-1941, and TF-1942 (manufactured by DIC Corporation), Ftergent 650A, 610FM, and 710FM (manufactured by Neos Corporation), and the like, but the surfactant is not limited thereto.

(Matting Particles)

The hard coat layer may contain matting particles having an average particle diameter of 1.0 μn to 10.0 μm, preferably 1.5 μm to 5.0 μm for the purpose of imparting internal scattering properties or imparting surface unevenness. In addition, a polymer compound or an inorganic laminar compound, and the like may also be included in order to adjust the viscosity of the coating liquid. (e) may also be used as the matting particles.

[Cellulose Acylate Film]

The polarizing plate protective film of the present invention has a cellulose acylate film having a thickness of 15 μm to 40 μm. The cellulose acylate film has a visible light transmittance of preferably 60% or more, more preferably 80% or more, and particularly preferably 90% or more.

The thickness of the cellulose acylate film is even more preferably 15 μm to 30 μm. The total thickness of the polarizing plate protective film may be reduced by making the thickness of the cellulose acylate film thin.

In the cellulose acylate film, an embodiment of including a compound represented by Formula I below is also preferred. The detailed mechanism is not clear, but the durability of the polarizer may be improved by using a cellulose acylate film including the compound represented by Formula I below. The compound may be used in combination with the composition for forming the hard coat layer of the present invention, thereby further improving the durability when the time has elapsed in a wet heat state.

(Compound Represented by Formula I)

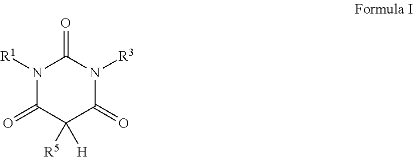

In Formula I, R¹, R³, and R⁵ each independently represent a hydrogen atom, an alkyl group, a cycloalkyl group, an alkenyl group, or an aromatic group. The alkyl group, the cycloalkyl group, the alkenyl group, and the aromatic group may have a substituent. Provided that any one of R¹, R³, and R⁵ is an alkyl group or cycloalkyl group substituted with a group having a cyclic structure, and the cyclic structures present in R¹, R³, and R⁵ are 3 or more in total.

The number of carbon atoms of the alkyl group in R¹, R³, and R⁵ is preferably 1 to 12, more preferably 1 to 10, even more preferably 1 to 5, and particularly preferably 1 to 3, and among them, a methyl group or an ethyl group is preferred. Provided that in the case of an alkyl group in which a group having a cyclic structure is substituted, the number of carbon atoms thereof is preferably 7 to 20, more preferably 7 to 12, and even more preferably 7 to 10. The cyclic structure in the alkyl group having a cyclic structure may be an aromatic ring (includes a heteroaromatic ring) or an aliphatic ring, but an aromatic hydrocarbon ring or an aliphatic ring is preferred.

The number of carbon atoms of the cycloalkyl group in R¹, R³, and R⁵ is preferably 3 to 20, more preferably 3 to 10, even more preferably 4 to 8, and particularly preferably 5 or 6. Specific examples of the cycloalkyl group include, for example, cyclopropyl, cyclopentyl, and cyclohexyl, and cyclohexyl is particularly preferred.

The number of carbon atoms of the alkenyl group in R¹, R³, and R⁵ is preferably 2 to 20, more preferably 2 to 10, and even more preferably 2 to 5. Examples thereof include vinyl and allyl.

The aromatic ring in R¹, R³, and R⁵ may be an aromatic hydrocarbon group or a heteroaromatic ring, but an aromatic hydrocarbon group is preferred. The number of carbon atoms of the aromatic group is preferably 6 to 20, more preferably 6 to 16, and even more preferably 6 to 12.

As the aromatic group, as the aromatic hydrocarbon group among the aromatic groups, phenyl and naphthyl are preferred, and phenyl is more preferred.

Each of the aforementioned groups of R¹, R³, and R⁵ may have a substituent.

The substituent is not particularly limited, and examples thereof include an alkyl group (has preferably 1 to 10 carbon atoms and is, for example, methyl, ethyl, isopropyl, t-butyl, pentyl, heptyl, 1-ethylpentyl, benzyl, and the like), an alkenyl group (has preferably 2 to 20 carbon atoms and is, for example, vinyl, allyl, oleyl, and the like), an alkynyl group (has preferably 2 to 20 and is, for example, ethynyl, 2-butynyl, phenylethynyl, and the like), a cycloalkyl group (has preferably 3 to 20 carbon atoms and is, for example, cyclopropyl, cyclopentyl, cyclohexyl, 4-methylcyclohexyl, and the like), an aryl group (has preferably 6 to 26 carbon atoms and is, for example, phenyl, 1-naphthyl, 4-methoxyphenyl, 2-chlorophenyl, 3-methylphenyl, and the like), a heterocyclic group (is preferably a heterocyclic group having 0 to 20 carbon atoms, a ring-constituting heteroatom is preferably an oxygen atom, a nitrogen atom, and a sulfur atom, is a 5-membered or 6-membered ring and may be condensed with a benzene ring or a hetero ring, the cycle may be a saturated ring, an unsaturated ring, or an aromatic ring, and is, for example, 2-pyridyl, 3-pyridyl, 4-pyridyl, 2-imidazolyl, 2-benzoimidazolyl, 2-thiazolyl, 2-oxazolyl, and the like), and alkoxy group (has preferably 1 to 20 carbon atoms and is, for example, methoxy, ethoxy, isopropyloxy, benzyloxy, and the like), an aryloxy (has preferably 6 to 26 carbon atoms and is, for example, phenoxy, 1-naphthyloxy, 3-methylphenoxy, 4-methoxyphenoxy, and the like),

an alkylthio group (has preferably 1 to 20 carbon atoms and is, for example, methylthio, ethylthio, isopropylthio, benzylthio, and the like), an arylthio group (has preferably 6 to 26 carbon atoms and is, for example, phenylthio, 1-naphthylthio, 3-methyl-phenylthiomethyl, 4-methoxyphenyl-thio, and the like), a sulfonyl group (is preferably an alkyl or arylsulfonyl group, has preferably 1 to 20 carbon atoms and is, for example, methylsulfonyl, ethylsulfonyl, benzenesulfonyl, toluenesulfonyl, and the like), an acyl group (includes an alkylcarbonyl group, an alkenylcarbonyl group, an arylcarbonyl group or a heterocyclic carbonyl group, has preferably 20 carbon atoms or less and is, for example, acetyl, pivaloyl group, acryloyl, methacryloyl, benzoyl, nicotinoyl, and the like), an alkoxycarbonyl group (has preferably 2 to 20 carbon atoms and is, for example, ethoxycarbonyl, 2-ethylhexyloxycarbonyl, and the like), an aryloxycarbonyl group (has 7 to 20 carbon atoms and is, for example, phenyloxycarbonyl, naphthyloxycarbonyl, and the like), an amino group (includes an amino group, an alkylamino group, an arylamino group or a heterocyclic amino group, has preferably 0 to 20 carbon atoms and is, for example, amino, N,N-dimethylamino, N,N-diethylamino, N-ethylamino, anilino, 1-pyrrolidinyl, piperidino, morphonyl, and the like), an sulfonamide group (is preferably an alkyl or arylsulfonamide group, has preferably 0 to 20 carbon atoms, and is, for example, N,N-dimethylsulfonamide, N-phenylsulfonamide, and the like), a sulfamoyl group (is preferably an alkyl or arylsulfamoyl group, has preferably 0 to 20 carbon atoms, and is, for example, N,N-dimethylsulfamoyl, N-phenylsulfamoyl, and the like), an acyloxy group (has preferably 1 to 20 carbon atoms and is, for example, acetyloxy, benzoyloxy, and the like), a carbamoyl group (is preferably an alkyl or arylcarbamoyl group, has preferably 1 to 20 carbon atoms, and is, for example, N,N-dimethylcarbamoyl, N-phenylcarbamoyl, and the like), an acylamino group (has preferably 1 to 20 carbon atoms and is, for example, acetylamino, acryloylamino, benzoylamino, nicotinamide, and the like), a cyano group, a hydroxy group, a mercapto group, a carboxyl group or a halogen atom (for example, a fluorine atom, a chlorine atom, a bromine atom, an iodine atom, and the like).

The aforementioned group may be additionally substituted with the aforementioned group. Examples of the additional substituent include a perfluoroalkyl group such as trifluoromethyl, an aralkyl group, an alkyl group substituted with an acyl group, and the like.

Meanwhile, these substituents are applied not only to the substituents which each group of R¹, R³, and R⁵ may have but also to the substituents in the compounds described in the present specification.

Here, among the aforementioned substituents which each group of R¹, R³, and R⁵ may have, an alkyl group, an aryl group, an alkoxy group, an alkylthio group, an alkylsulfonyl group, a halogen atom, and an acyl group are preferred, an alkyl group, an aryl group, an alkoxy group, and an acyl group are more preferred, and an alkyl group and an alkoxy group are even more preferred.

In the compound represented by Formula I, any one of R¹, R³, and R⁵ is an alkyl group or cycloalkyl group substituted with a group having a cyclic structure, and any one of R¹, R³, and R⁵ is preferably an alkyl group substituted with a group having a cyclic structure.

Among them, R⁵ is preferably an alkyl group or cycloalkyl group substituted with a group having a cyclic structure.

Here, the cycle of the group having the cyclic structure is preferably a benzene ring, a naphthalene ring, a cyclopentane ring, a cyclohexane ring, a nitrogen-containing heteroaromatic ring (for example, a pyrrole ring, a pyrazole ring, an imidazole ring, an oxazole ring, a thiazole ring, a pyridine ring, an indole ring, and an iso-indole ring).

In addition, the compound represented by Formula I is preferably an alkyl group or cycloalkyl group in which at least two of R¹, R³, and R⁵ have a cyclic structure as a substituent. Furthermore, the case where R¹ and R³ are each independently an alkyl group which may have a substituent, an aromatic group which may have a substituent, or a cyclcoalkyl group is preferred among them.

The compound represented by Formula I is more preferably a compound in which the sum of cyclic structures present in the substituent of R¹, R³, and R⁵ is up to 4.

R⁵ is preferably an alkyl group or cycloalkyl group which may be substituted with a group having a cyclic structure or an acyl group, more preferably an alkyl group substituted with an aryl group and an alkyl group or cycloalkyl group substituted with an acyl group, and even more preferably an alkyl group or cycloalkyl group substituted with an aryl group.

Hereinafter, the aforementioned preferred alkyl group and cycloalkyl group in R⁵ will be further described.

Among the alkyl groups, examples of an unsubstituted alkyl group include methyl, ethyl, propyl, isopropyl, n-butyl, n-hexyl, 2-ethylhexyl, and n-octyl.

Examples of the alkyl group substituted with a group having a cyclic structure include an aralkyl group such as benzyl, phenethyl, 3-phenylpropyl, and naphthylmethyl, pyridine-2-yl methyl, pyridine-3-yl methyl, pyridine-4-yl methyl, and indole-3-yl methyl.

The acyl group in the alkyl group substituted with the acyl group is preferably an alkylcarbonyl group, a cycloalkylcarbonyl group, and an arylcarbonyl group, and among them, a cycloalkylcarbonyl group having a cyclic structure and an arylcarbonyl group are preferred, and an arylcarbonyl group is particularly preferred.

Examples of the aforementioned alkylcarbonyl group include acetyl, propionyl, butyryl, and pivaloyl, examples of the cycloalkylcarbonyl group include cyclopropylcarbonyl, cyclopentylcarbonyl, and cyclohexylcarbonyl, and examples of the arylcarbonyl group include benzoyl, toluoyl, and naphthoyl.

Examples of the alkyl group substituted with an acyl group include a 2-acylethyl group, a 3-acylpropyl group, and a 2-acylpropyl group, and a 2-acylethyl group is preferred.

Examples of the cycloalkyl group include the groups exemplified in R¹, R³, and R⁵.

Among the compounds represented by Formula 1, preferred examples will be exemplified as follows.
Compounds in which at least one of R¹, R³, and R⁵ is an alkyl group substituted with an aromatic ring

Meanwhile, among the alkyl groups substituted with an aromatic ring, it is preferred that an alkyl group is substituted with one or two alkyl group(s) (when the alkyl group is substituted with two aryl groups, it is preferred that the alkyl group is substituted with the same carbon atom). Furthermore, it is also preferred that the alkyl group is substituted with an aryl group and an acyl group (preferably an aryloyl group).
Compound in which any one of R¹, R³, and R⁵ is a group including a cycloalkyl group, and preferably, a group including a cycloalkyl group is a cycloalkyl group

Examples of the cyclic structure in the case of “the cyclic structures present in R¹, R³, and R⁵ are 3 or more in total” include an embodiment in which the substituent of R¹, R³, or R⁵ has a cyclic structure as already exemplified, in addition to the case where the basic structure of the substituent of R¹, R³, or R⁵ itself has a cyclic structure.

As the cyclic structure, a cyclic saturated hydrocarbon structure or an aromatic ring structure (aromatic hydrocarbon structure or heteroaromatic ring structure). Further, the cyclic structure may be a condensed ring structure.

When the cyclic structure is a cyclic saturated hydrocarbon structure, it is preferred that the cyclic saturated hydrocarbon structure is present as a cycloalkyl group having 3 to 20 carbon atoms. More specifically, it is more preferred that the structure is present as a cyclopropyl group, a cyclopentyl group, or a cyclohexyl group, and it is particularly preferred that the structure is present as a cyclohexyl group.

In addition, when the cyclic structure is an aromatic ring structure, it is preferred that the structure is an aromatic hydrocarbon structure. It is preferred that the aromatic hydrocarbon structure is present as an aryl group having 6 to 20 carbon atoms. More specifically, it is more preferred that the structure is present as a benzene ring or a naphthalene ring, and it is particularly preferred that the structure is present as a benzene ring.

The cyclic structure may have a substituent, and when the structure has a substituent, preferred ranges thereof are the same as those of a substituent which each of R¹, R³, and R⁵ may have.

The compound represented by Formula I is more preferably a compound in which R¹, R², and R³ are an alkyl group, an alkenyl group, or an aryl group. Furthermore, it is more preferred that R¹, R³, and R⁵ each have one or more cyclic structures, and even more preferred that R¹, R³, and R⁵ each have one cyclic structure.

The molecular weight of the compound represented by Formula I is preferably 250 to 1,200, more preferably 300 to 800, and particularly preferably 350 to 600.

By setting the molecular weight to these preferred ranges, it is possible to obtain a film which is excellent in suppressing volatilization from the film of the compound represented by Formula 1 and is highly transparent.

Hereinafter, specific examples of the compound represented by Formula 1 used in the present invention will be shown, but the present invention is not limited thereto.

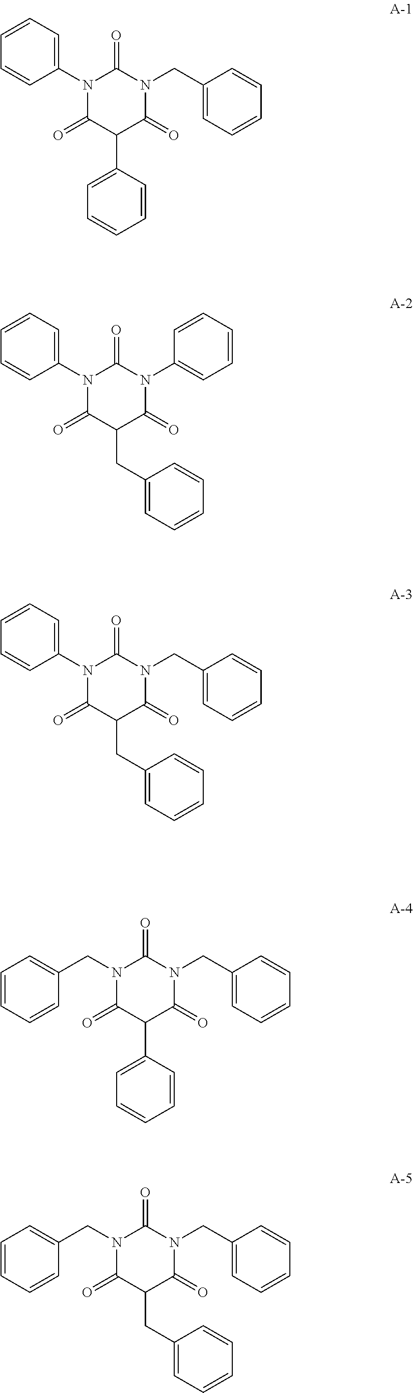 [SMILES: O=C1C(c2ccccc2)C(=O)N(c2ccccc2)C(=O)N1Cc1ccccc1 ; O=C1C(Cc2ccccc2)C(=O)N(c2ccccc2)C(=O)N1c1ccccc1 ; O=C1C(Cc2ccccc2)C(=O)N(c2ccccc2)C(=O)N1Cc1ccccc1 ; O=C1C(c2ccccc2)C(=O)N(Cc2ccccc2)C(=O)N1Cc1ccccc1 ; O=C1C(Cc2ccccc2)C(=O)N(Cc2ccccc2)C(=O)N1Cc1ccccc1]

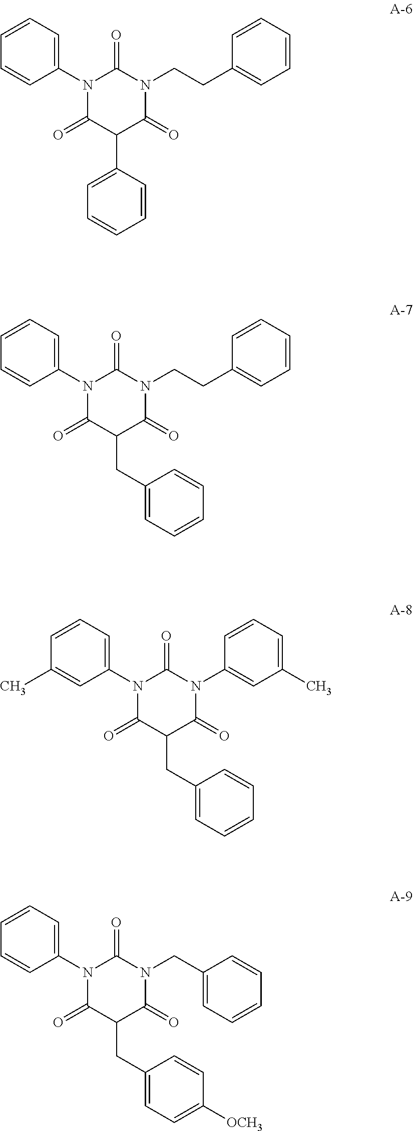

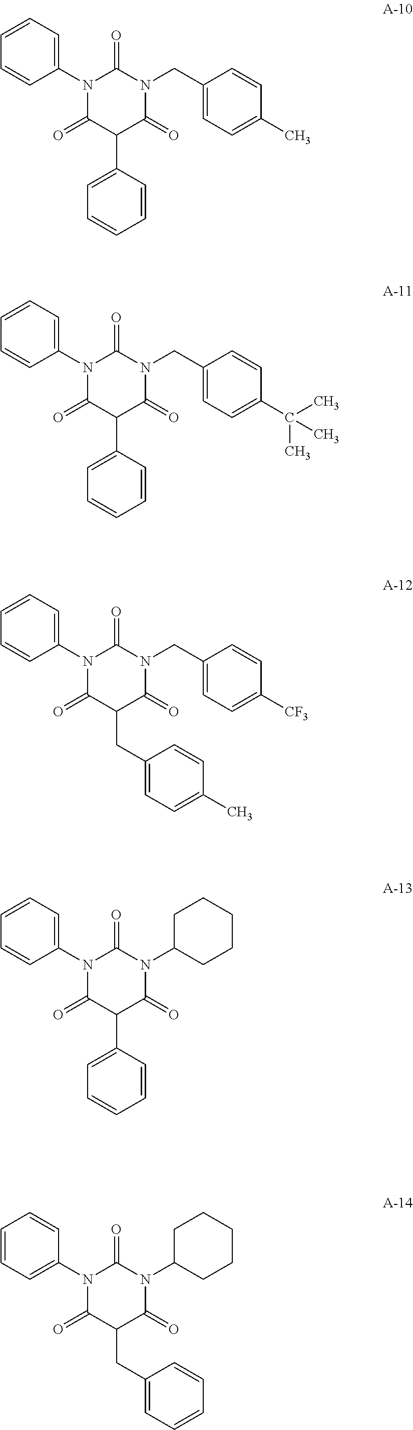 [SMILES: Cc1ccc(CN2C(=O)C(c3ccccc3)C(=O)N(c3ccccc3)C2=O)cc1 ; CC(C)(C)c1ccc(CN2C(=O)C(c3ccccc3)C(=O)N(c3ccccc3)C2=O)cc1 ; Cc1ccc(CC2C(=O)N(Cc3ccc(C(F)(F)F)cc3)C(=O)N(c3ccccc3)C2=O)cc1 ; O=C1C(c2ccccc2)C(=O)N(C2CCCCC2)C(=O)N1c1ccccc1 ; O=C1C(Cc2ccccc2)C(=O)N(C2CCCCC2)C(=O)N1c1ccccc1]

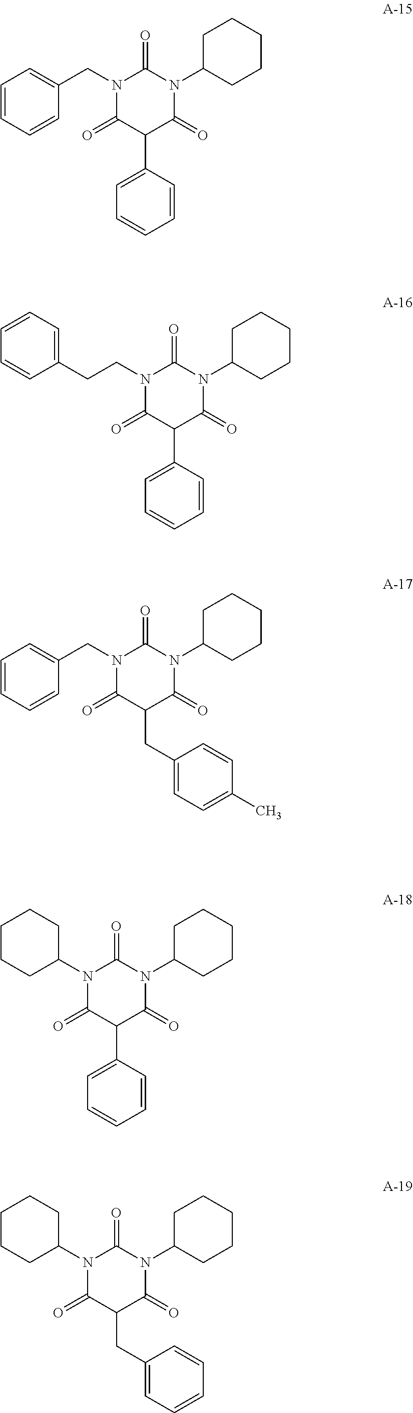 [SMILES: O=C1C(c2ccccc2)C(=O)N(C2CCCCC2)C(=O)N1Cc1ccccc1 ; O=C1C(c2ccccc2)C(=O)N(C2CCCCC2)C(=O)N1CCc1ccccc1 ; Cc1ccc(CC2C(=O)N(Cc3ccccc3)C(=O)N(C3CCCCC3)C2=O)cc1 ; O=C1C(c2ccccc2)C(=O)N(C2CCCCC2)C(=O)N1C1CCCCC1 ; O=C1C(Cc2ccccc2)C(=O)N(C2CCCCC2)C(=O)N1C1CCCCC1]

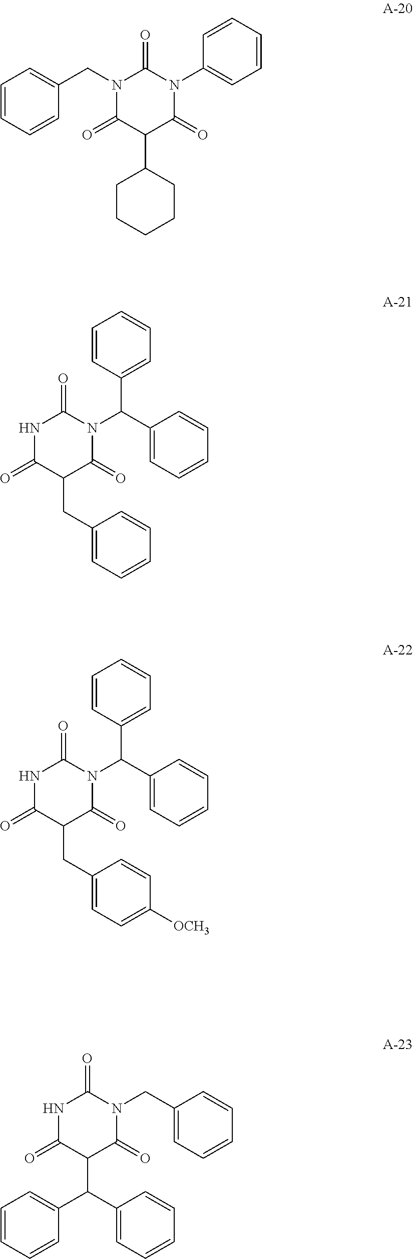 [SMILES: O=C1C(C2CCCCC2)C(=O)N(c2ccccc2)C(=O)N1Cc1ccccc1 ; O=C1NC(=O)N(C(c2ccccc2)c2ccccc2)C(=O)C1Cc1ccccc1 ; COc1ccc(CC2C(=O)NC(=O)N(C(c3ccccc3)c3ccccc3)C2=O)cc1 ; O=C1NC(=O)N(Cc2ccccc2)C(=O)C1C(c1ccccc1)c1ccccc1]

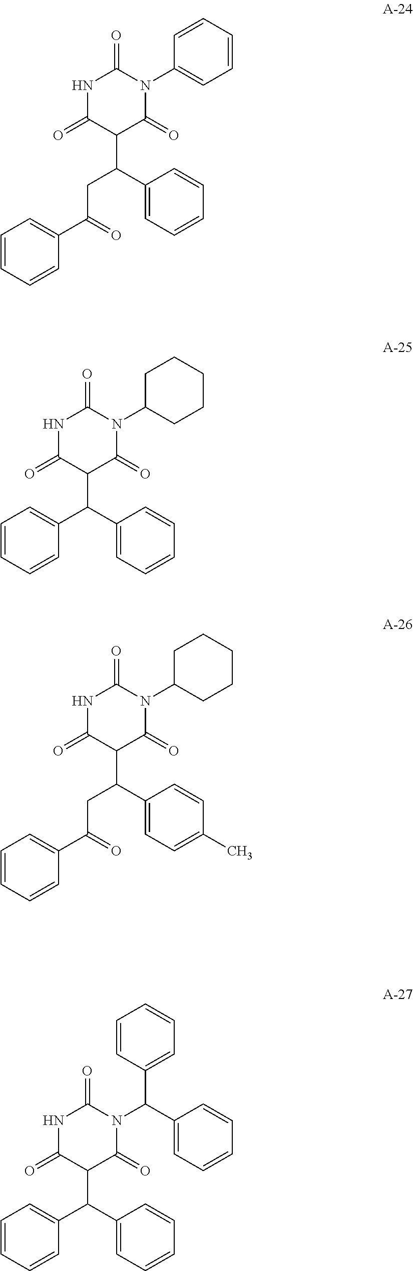 [SMILES: O=C(CC(c1ccccc1)C1C(=O)NC(=O)N(c2ccccc2)C1=O)c1ccccc1 ; O=C1NC(=O)N(C2CCCCC2)C(=O)C1C(c1ccccc1)c1ccccc1 ; Cc1ccc(C(CC(=O)c2ccccc2)C2C(=O)NC(=O)N(C3CCCCC3)C2=O)cc1 ; O=C1NC(=O)N(C(c2ccccc2)c2ccccc2)C(=O)C1C(c1ccccc1)c1ccccc1]

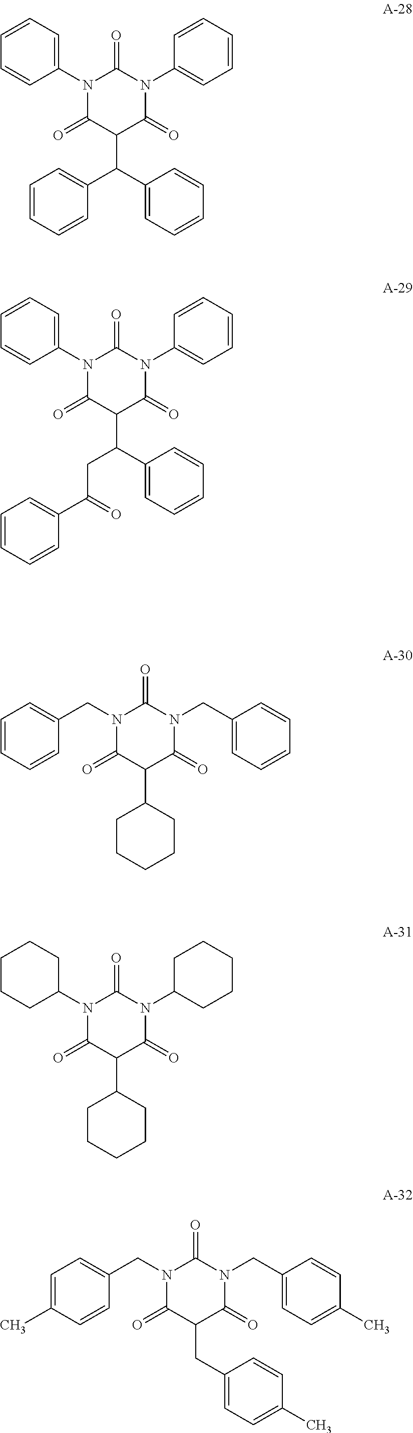

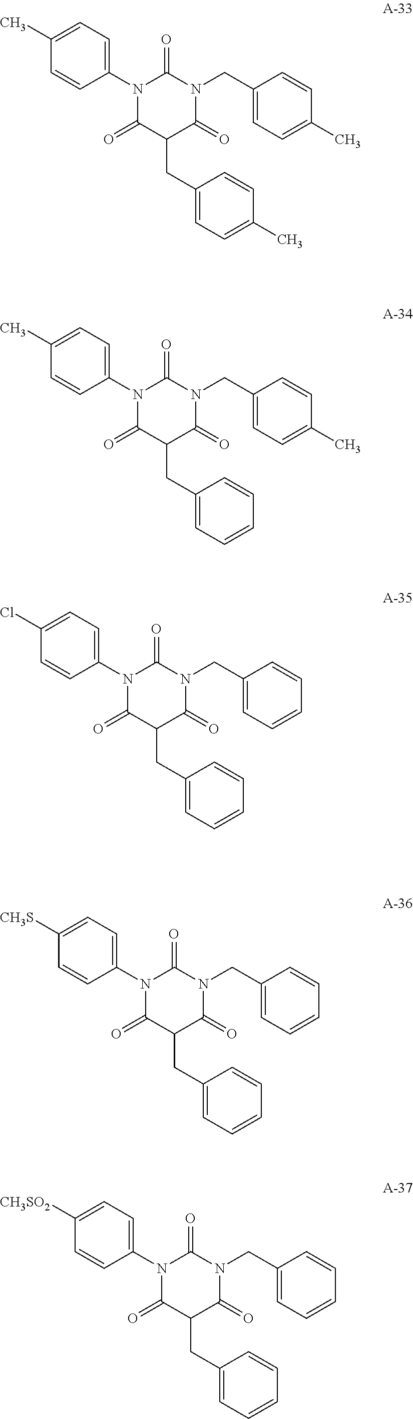

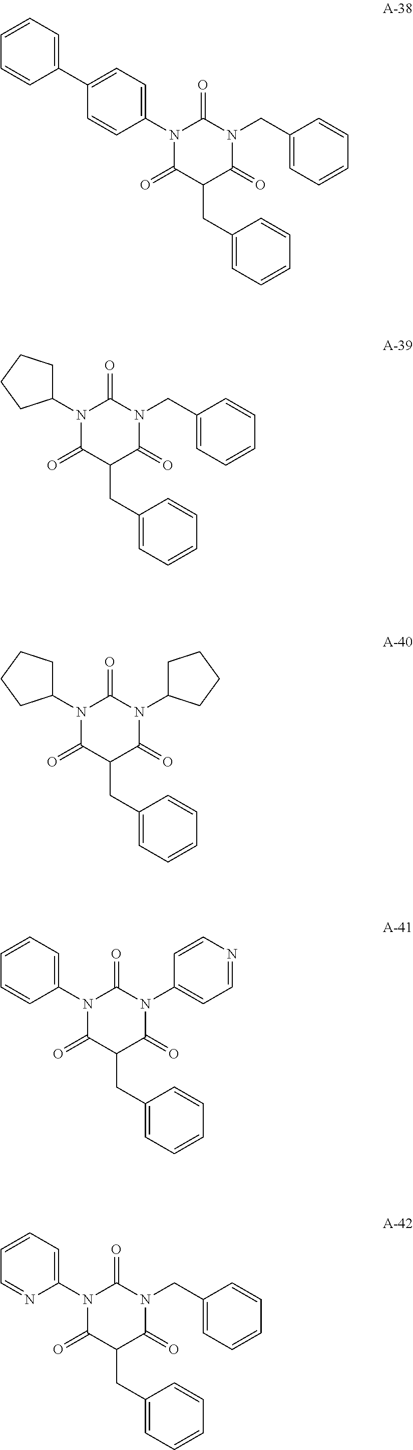 [SMILES: O=C1C(Cc2ccccc2)C(=O)N(c2ccc(-c3ccccc3)cc2)C(=O)N1Cc1ccccc1 ; O=C1C(Cc2ccccc2)C(=O)N(C2CCCC2)C(=O)N1Cc1ccccc1 ; O=C1C(Cc2ccccc2)C(=O)N(C2CCCC2)C(=O)N1C1CCCC1 ; O=C1C(Cc2ccccc2)C(=O)N(c2ccncc2)C(=O)N1c1ccccc1 ; O=C1C(Cc2ccccc2)C(=O)N(c2ccccn2)C(=O)N1Cc1ccccc1]

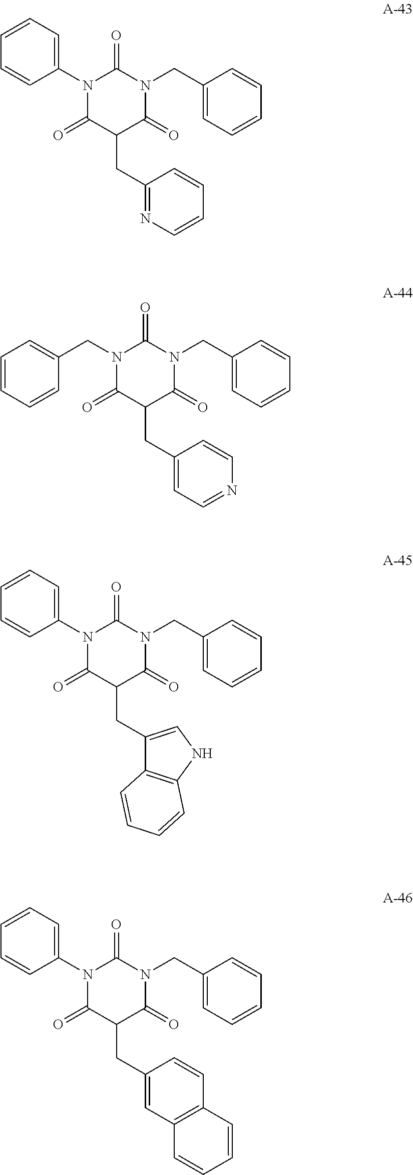 [SMILES: O=C1C(Cc2ccccn2)C(=O)N(c2ccccc2)C(=O)N1Cc1ccccc1 ; O=C1C(Cc2ccncc2)C(=O)N(Cc2ccccc2)C(=O)N1Cc1ccccc1 ; O=C1C(Cc2c[nH]c3ccccc23)C(=O)N(c2ccccc2)C(=O)N1Cc1ccccc1 ; O=C1C(Cc2ccc3ccccc3c2)C(=O)N(c2ccccc2)C(=O)N1Cc1ccccc1]

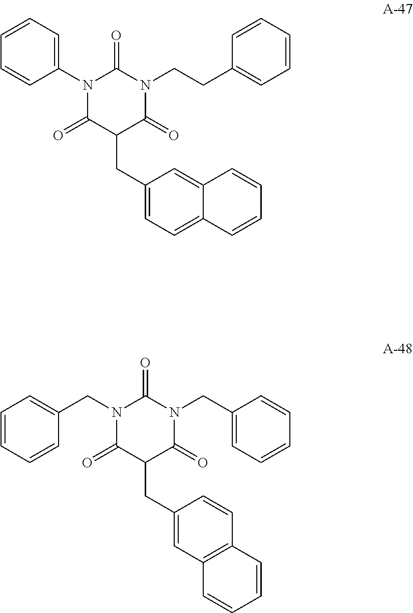 [SMILES: O=C1C(Cc2ccc3ccccc3c2)C(=O)N(c2ccccc2)C(=O)N1CCc1ccccc1 ; O=C1C(Cc2ccc3ccccc3c2)C(=O)N(Cc2ccccc2)C(=O)N1Cc1ccccc1]

It is known that the compound represented by Formula I may be synthesized by using a method of synthesizing barbituric acid which condenses a urea derivative and a malonic acid derivative. Barbituric acid having two substituents on the N atoms is obtained by heating a N,N′-disubstituted urea with malonic acid chloride, or by mixing a N,N′-disubstituted urea with malonic acid and an activator such as acetic anhydride and heating the mixture. For example, methods described in Journal of the American Chemical Society, vol. 61, p. 1015 (1939), Journal of Medicinal Chemistry, vol. 54, p. 2409 (2011), Tetrahedron Letters, vol. 40, p. 8029 (1999), and the pamphlet of WO2007/150011 may be preferably used.

Furthermore, the malonic acid used for the condensation may be an unsaturated malonic acid or a malonic acid having a substituent, and when a malonic acid having a substituent corresponding to R⁵ is used, the compound represented by Formula I may be synthesized by constructing barbituric acid. Further, since a barbituric acid unsubstituted in the 5 position may be obtained when an unsubstituted malonic acid is condensed with a urea derivative, the compound represented by Formula 1 may also be synthesized by modifying the obtained barbituric acid.

As a method of modifying the 5 position, it is possible to use a nucleophilic substitution reaction with a halogenated alkyl, and the like, or an addition reaction such as the Michael addition reaction. In addition, a method using dehydrating condensation with an aldehyde or ketone to produce an alkylidene or arylidene compound, and then reducing the double bond may be preferably used. For example, a reduction method by zinc is described in Tetrahedron Letters, vol. 44, p. 2203 (2003), a reduction method by contact reduction is described in Tetrahedron Letters, vol. 42, p. 4103 (2001) or Journal of the American Chemical Society, vol. 119, p. 12849 (1997), and reduction process by NaBH₄ is described in Tetrahedron Letters, vol. 28, p. 4173 (1987), and the like. All the methods are synthesis methods which may be preferably used in the case where barbituric acid has an aralkyl group or a cycloalkyl group at 5-position.

Meanwhile, methods of synthesizing the compound represented by Formula I are not limited to those described above.

The content of the compound represented by Formula I in the transparent support is not particularly limited. However, the content is preferably 0.1 part by mass to 20 parts by mass, more preferably 0.2 part by mass to 15 parts by mass, and particularly preferably 0.3 part by mass to 10 parts by mass with respect to 100 parts by mass of the resin which forms the transparent support.

By setting the amount of the compound represented by Formula I added to the aforementioned range, the water vapor transmission rate may be effectively reduced, and haze is suppressed from being generated.

The compound represented by Formula I may be added in the form of hydrate, solvate or salt. Meanwhile, in the present invention, the hydrate may contain an organic solvent, and the solvate may contain water. That is, the “hydrate” and “solvate” include a mixed solvate including any of water and an organic solvent.

Examples of the solvent which the solvate includes include any of general organic solvents. Specific examples thereof include alcohols (for example, methanol, ethanol, 2-propanol, 1-butanol, 1-methoxy-2-propanol, and t-butanol), esters (for example, ethyl acetate), hydrocarbons (any of aliphatic or aromatic hydrocarbons are acceptable, for example, toluene, hexane and heptane), ethers (for example, diethyl ether and tetrahydrofuran), nitriles (for example, acetonitrile), ketones (for example, acetone and 2-butanone), and the like. The solvent is preferably a solvate of alcohol, and more preferably methanol, ethanol, 2-propanol, and 1-butanol. These solvents may be any of reaction solvents used during the synthesis of the compound represented by Formula I, may be solvents used during the crystallization and purification after the synthesis, or may be mixed solvents thereof.

Furthermore, two or more species of solvents may concurrently be included, or water and solvent may be included together (for example, water and alcohol (for example, methanol, ethanol, and t-butanol), and the like).

As the salt, an acid addition salt formed of an inorganic or organic acid is included. Examples of the inorganic acid include hydrohalogenic acids (hydrochloric acid and hydrobromic acid), sulfuric acid, phosphoric acid, and the like. Further, examples of the organic acid include acetic acid, trifluoroacetic acid, oxalic acid, and citric acid, and alkanesulfonic acids (methanesulfonic acid), and arylsulfonic acids (benzenesulfonic acid, 4-toluenesulfonic acid, and 1,5-naphthalenedisulfonic acid).

Examples of the salt include those formed when the acidic moiety present in the parent compound is substituted with a metal ion (for example, alkali metal salts, for example, sodium or potassium salts, alkali earth metal salts, for example, calcium or magnesium salts, ammonium salt alkali metal ion, alkali earth metal ion, or aluminum ion), or when prepared using an organic base (ethanolamine, diethanolamine, triethanolamine, morpholine, and piperidine), and are not limited thereto. Among them, sodium salt and potassium salt are preferred.

[Layer Configuration of Polarizing Pate Protective Film]

The polarizing plate protective film of the present invention is generally a configuration in which a hard coat layer is applied and formed on a cellulose acylate film (support) in the simplest configuration.

Examples of a preferred layer configuration of the polarizing plate protective film of the present invention will be described below, but are not particularly limited to these layer configurations.
Support/Hard Coat Layer
Support/Hard Coat Layer/Low Refractive Index Layer
Support/Hard Coat Layer/Antiglare Layer (Antistatic Layer)/Low Refractive Index Layer
Support/Hard Coat Layer/Antiglare Layer/Antistatic Layer/Low Refractive Index Layer
Support/Hard Coat Layer/Antiglare Layer/Antistatic Layer/Low Refractive Index Layer
Support/Hard Coat Layer (Antistatic Layer)/Antiglare Layer/Low Refractive Index Layer
Support/Hard Coat Layer/High Refractive Index Layer/Antistatic Layer/Low Refractive Index Layer
Support/Hard Coat Layer/High Refractive Index Layer (Antistatic Layer)/Low Refractive Index Layer
Support/Hard Coat Layer/Antistatic Layer/High Refractive Index Layer/Low Refractive Index Layer
Support/Hard Coat Layer/Intermediate Refractive Index Layer/High Refractive Index Layer (Antistatic Layer)/Low Refractive Index Layer
Support/Hard Coat Layer/Intermediate Refractive Index Layer (Antistatic Layer)/High Refractive Index Layer/Low Refractive Index Layer
Support/Hard Coat Layer (Antistatic Layer)/Intermediate Refractive Index Layer/High Refractive Index Layer/Low Refractive Index Layer
Support/Antistatic Layer/Hard Coat Layer/Intermediate Refractive Index Layer/High Refractive Index Layer/Low Refractive Index Layer
Antistatic Layer/Support/Hard Coat Layer/Intermediate Refractive Index Layer/High Refractive Index Layer/Low Refractive Index Layer

Here, the antistatic layer and the antiglare layer may have hard coat properties.

<Preparation Method of Polarizing Plate Protective Film>

The method for preparing the polarizing plate protective film of the present invention is not particularly limited, but the following aspect is preferred. That is, a method for preparing a polarizing plate protective film including a hard coat layer having a film thickness of 3 μm to 10 μm on at least one surface of a cellulose acylate film having a thickness of 15 μm to 40 μm, wherein the polarizing plate protective film has a WVTR_{A} of 300 g/m²/day or less and a ratio WVTR_{A}/WVTR_{B} of 0.6 to 1.0 when a water vapor transmission rate under environments of a temperature of 40° C. and a relative humidity of 90% is defined as WVTR_{A} and a water vapor transmission rate under environments of a temperature of 40° C. and a relative humidity of 90% after being exposed to the environments of a temperature of 85° C. and a relative humidity of 85% for 24 hours is defined as WVTR₈, the method including:

applying, on at least one surface of the cellulose acylate film having a thickness of 15 μm to 40 μm, a composition for forming a hard coat layer containing:

(a) a compound having at least one alicyclic epoxy group in the molecule;

(b) a compound having three or more ethylenically unsaturated double bond groups in the molecule;

(c) a radical polymerization initiator; and

(d) a cationic polymerization initiator,

drying and ultraviolet (UV)-curing the composition,

wherein the ultraviolet-curing of the composition is a process in which UV rays are irradiated by setting a film-surface temperature to 40° C. or less and an irradiation dose to 30 mJ/cm² or more, and then irradiated by setting a film-surface temperature of 50° C. or more and an irradiation dose to 200 mJ/cm² or more.

[Application Method]

It is preferred that the composition for forming the hard coat layer is formed by the following application method, but the application method is not limited to these methods. Publicly known methods, such as a dip coat method, an air knife method, a curtain coat method, a roller coat method, a wire bar coat method, a gravure coat method, a slide coat method or an extrusion coat method (die coat method) (see the specification of Japanese Patent Laid-Open Publication No. 2003-164788), and a microgravure method, are used, and among them, a microgravure method and a die coat method are preferred.

[Drying and Curing Conditions]

The drying method of a composition for forming the hard coat layer, which is applied on a cellulose acylate film, is not particularly limited, but drying by heat or wind is preferred. The drying temperature is not particularly limited, but is preferably 30° C. to 60° C., and more preferably 40° C. to 50° C.

The UV-curing of the composition is preferably a process in which UV rays are irradiated by setting a film-surface temperature to 40° C. or less and an irradiation dose to 30 mJ/cm² or more, and then irradiated by setting a film-surface temperature of 50° C. or more and an irradiation dose to 200 mJ/cm² or more, as described above.

The present inventors have thought that when UV rays are irradiated at a film-surface temperature of more than 40° C. in the initial phase of the process of UV curing, Compound (b) in the composition for forming the hard coat layer is first cured, and Compound (a) (compound having an epoxy group) may be made immovable, and thus the hard coat layer may not be cured.

In the UV-curing of the composition, it is thought that after UV rays are irradiated by initially setting the film-surface temperature to 40° C. or less and the irradiation dose to 30 mJ/cm² or more, UV rays are irradiated by setting the film-surface temperature to 50° C. or more and the irradiation dose to 200 mJ/cm² or more, Compound (a) and Compound (b) are efficiently reacted, and thus a stable network structure may be formed and the stability of the water vapor transmission rate may be enhanced, and simultaneously, the WVTRA and the WVTR_{A}/WVTR_{B} of the polarizing plate protective film may be adjusted to a desired range, so that when the polarizing plate protective film is used for the polarizing plate, the polarizer may be prevented from deteriorating, thereby improving the durability.

<Polarizing Plate>

The polarizing plate protective film of the present invention may be used as a polarizing plate having hard coat properties by using a polarizing plate composed of a polarizer and a protective film disposed at both sides thereof at one side or both sides of the protective film thereof.

The polarizing plate protective film may be used as a protective film at one side, and a typical cellulose acetate film may be used in a protective film at the other side, but it is preferred to use a cellulose acetate film prepared by a solution film forming method and stretched in a width direction in the roll film form at a stretching magnification of 10% to 100% in the protective film at the other side.

Further, it is also a preferred aspect that among the two protective films disposed at both sides of the polarizer, the film other than the polarizing plate protective film of the present invention is an optically-compensatory film having an optically-compensatory layer including an optically anisotropic layer. The optically-compensatory film (phase difference film) may improve viewing angle characteristics of a liquid crystal display screen. As the optically-compensatory film, those publicly known may be used, but an optically-compensatory film described in Japanese Patent Laid-Open Publication No. 2001-100042 is preferred from the viewpoint of broadening the viewing angle.

Examples of the polarizer include an iodine-based polarizer, a dye-based polarizer which uses a dichroic dye, and a polyene-based polarizer. The iodine-based polarizer and the dye-based polarizer are generally prepared by using a polyvinyl alcohol-based film.

In addition, as the polarizer, a publicly known polarizer or a polarizer cut from a lengthwise polarizer whose absorption axis is neither parallel to nor vertical to the longitudinal direction may be used. The lengthwise polarizer whose absorption axis is neither parallel to nor vertical to the longitudinal direction of the polarizer is prepared by the following method.

That is, the polarizer may be prepared by a method for stretching a polymer film such as a polyvinyl alcohol-based film continuously supplied by imparting a tension thereto while holding both ends of the polymer film with holding units, in which a length at least in the width direction of the film is stretched by 1.1 to 20.0 times, a difference of a travelling speed in a longitudinal direction between the devices which hold the both ends of the film is within 3% or less, and the travelling direction of the film is inflected such that an angle formed by the travelling direction of the film and the substantial direction of stretching the film at the outlet of a process of holding the both ends of the film is inclined by 20° to 700, in the state of holding the both ends of the film. The polarizer which has been inclined particularly by 45° is preferably used from the viewpoint of the productivity.

The method for stretching the polymer film is described in detail in paragraph nos. 0020 to 0030 of Japanese Patent Laid-Open Publication No. 2002-86554.

<Image Display Device>

The polarizing plate protective film or polarizing plate of the present invention may be used for an image display device such as a liquid crystal display device (LCD), a plasma display panel (PDP), an electroluminescent display (ELD), or a cathode ray tube display device (CRT).

Particularly preferred is a liquid display device including a liquid crystal cell and the polarizing plate of the present invention disposed at least one surface of the liquid crystal cell, in which the hard coat film of the present invention is disposed at the outermost surface of the hard coat film of the present invention.

The polarizing plate protective film or polarizing plate of the present invention may maintain the display image quality of a display such as a liquid crystal display device at a high grade over a long period of time.

### EXAMPLES

The present invention will be described with reference to the following Examples in order to describe the present invention in detail, but the present invention is not limited to these Examples.

(Preparation of Composition for Forming Hard Coat Layer)

Coating Liquids A01 to A26 and B01 to B06 were prepared by adding each component so as to have the composition described in the following Tables 1 to 3, and filtering the resulting mixture with a polypropylene-made filter having a pore diameter of 10 μm. The value of each component except for the solvents in Tables 1 to 3 indicates “mass % with respect to the total solid content” of each component.

A material diluted with a solvent, such as ELECOM V-8802, is also added by adjusting the solid content ratio so as to become those described in Tables 1 and 2. With respect to the solvent, a composition for forming a hard coat layer, whose solid content concentration is 50 mass %, was prepared by adjusting the solvent ratio so as to become the ratio described in Tables 1 to 3.

TABLE 1

| Composition | | | | | | | | | | | | | | |
|---|---|---|---|---|---|---|---|---|---|---|---|---|---|---|
| for Forming | | | | | | | | | | | | | | |
| Hard Coat Layer | | A01 | A02 | A03 | A04 | A05 | A06 | A07 | A08 | A09 | A10 | A11 | A12 | A13 |
| Com- | 3,4- | 25.0% | 25.0% | 25.0% | | 25.0% | | | 25.0% | 25.0% | 25.0% | 25.0% | 25.0% | 25.0% |
| pound | Epoxy- | | | | | | | | | | | | | |
| (a) | cyclo- | | | | | | | | | | | | | |
| (mass %) | hexyl- | | | | | | | | | | | | | |
| | methyl | | | | | | | | | | | | | |
| | (Meth) | | | | | | | | | | | | | |
| | acrylate | | | | | | | | | | | | | |
| | 3,4- | | | | 25.0% | | | | | | | | | |
| | Epoxy- | | | | | | | | | | | | | |
| | cyclo- | | | | | | | | | | | | | |
| | hexylbutyl | | | | | | | | | | | | | |
| | (Meth) | | | | | | | | | | | | | |
| | acrylate | | | | | | | | | | | | | |
| | Epoxy | | | | | | 20.0% | | | | | | | |
| | Polymer A | | | | | | | | | | | | | |
| | Epoxy | | | | | | | 25.0% | | | | | | |
| | Polymer B | | | | | | | | | | | | | |
| Com- | DPHA | 69.9% | 35.0% | | 69.9% | 69.9% | 74.9% | 69.9% | 54.9% | 54.9% | 55.9% | 55.9% | 58.9% | 54.9% |
| pound | PETA | | 35.0% | | | | | | | | | | | |
| (b) | U-4HA | | | 69.9% | | | | | | | | | | |
| (mass %) | | | | | | | | | | | | | | |
| Com- | Irgacure | | | | | | | | | | | | 4.0% | |
| ponent | 907 | | | | | | | | | | | | | |
| (c) | (λc = | | | | | | | | | | | | | |
| (mass %) | 307 nm) | | | | | | | | | | | | | |
| | Irgacure | | | | | | | | | 4.0% | 4.0% | 4.0% | | 4.0% |
| | 184 | | | | | | | | | | | | | |
| | (λc = | | | | | | | | | | | | | |
| | 244 nm) | | | | | | | | | | | | | |
| | Irgacure | 4.0% | 4.0% | 4.0% | 4.0% | 4.0% | 4.0% | 4.0% | 4.0% | | | | | |
| | 127 | | | | | | | | | | | | | |
| | (λc = | | | | | | | | | | | | | |
| | 264 um) | | | | | | | | | | | | | |
| Com- | Irgacure | | | | | | | | | | | 1.0% | | |
| ponent | 270 | | | | | | | | | | | | | |
| (d) | (λd = | | | | | | | | | | | | | |
| (mass %) | 322 nm) | | | | | | | | | | | | | |
| | WPI-170 | | | | | | | | | | 1.0% | | | |
| | (λd = | | | | | | | | | | | | | |
| | 251 nm) | | | | | | | | | | | | | |
| | Cationic | 1.0% | 1.0% | 1.0% | 1.0% | 1.0% | 1.0% | 1.0% | 1.0% | 1.0% | | | 1.0% | 1.0% |
| | Poly- | | | | | | | | | | | | | |
| | merization | | | | | | | | | | | | | |
| | Initiator A | | | | | | | | | | | | | |
| | (λd = | | | | | | | | | | | | | |
| | 280 nm) | | | | | | | | | | | | | |
| Com- | ELECOM | | | | | | | | 15.0% | 15.0% | 15.0% | 15.0% | 15.0% | |
| ponent | V-8802 | | | | | | | | | | | | | |
| (e) | MiBK-ST | | | | | | | | | | | | | 15.0% |
| (mass %) | | | | | | | | | | | | | | |
| Sur- | FP-1 | 0.1% | 0.1% | 0.1% | 0.1% | 0.1% | 0.1% | 0.1% | 0.1% | 0.1% | 0.1% | 0.1% | 0.1% | 0.1% |
| factant | | | | | | | | | | | | | | |
| (mass %) | | | | | | | | | | | | | | |
| Solvent | Methyl | 40% | 40% | 40% | 40% | 40% | 40% | 40% | 40% | 40% | 40% | 40% | 40% | 40% |
| (mass %) | Ethyl | | | | | | | | | | | | | |
| | Ketone | | | | | | | | | | | | | |
| | Methyl | 50% | 50% | 50% | 50% | 50% | 50% | 50% | 50% | 50% | 50% | 50% | 50% | 50% |
| | Isobutyl | | | | | | | | | | | | | |
| | Ketone | | | | | | | | | | | | | |
| | Methyl | 10% | 10% | 10% | 10% | 10% | 10% | 10% | 10% | 10% | 10% | 10% | 10% | 10% |
| | Acetate | | | | | | | | | | | | | |

| | | | | | | | | | | | | | |
|---|---|---|---|---|---|---|---|---|---|---|---|---|---|
| Remark | Ex. | Ex. | Ex. | Ex. | Ex. | Ex. | Ex. | Ex. | Ex. | Ex. | Ex. | Ex. | Ex. |

TABLE 2

| Composition for Forming | | | | | | | | | |
|---|---|---|---|---|---|---|---|---|---|
| Hard Coat Layer | | A14 | A15 | A16 | A17 | A18 | A19 | A20 | A21 |
| Compound | 3,4-Epoxy- | 25.0% | 25.0% | 25.0% | 25.0% | 25.0% | 25.0% | 25.0% | 15.0% |
| (a) (mass %) | cyclohexyl-methyl | | | | | | | | |
| | (Meth)acrylate | | | | | | | | |
| Compound | DPHA | 54.9% | 54.9% | 54.9% | 54.9% | 53.7% | 53.7% | 53.7% | 63.7% |
| (b) (mass %) | | | | | | | | | |
| Component | Irgacure 184 | 4.0% | 4.0% | 4.0% | 4.0% | 4.0% | 4.0% | 4.0% | 4.0% |
| (c) | (λc = 244 nm) | | | | | | | | |
| (mass %) | | | | | | | | | |
| Component | Cationic | 1.0% | 1.0% | 1.0% | 1.0% | 1.0% | 1.0% | 1.0% | 1.0% |
| (d) | Polymerization | | | | | | | | |
| (mass %) | Initiator A | | | | | | | | |
| | (λd = 280 nm) | | | | | | | | |
| Component | ELECOM | 15.0% | 15.0% | 15.0% | 15.0% | 15.0% | 15.0% | 15.0% | 15.0% |
| (e) | V-8802 | | | | | | | | |
| (mass %) | | | | | | | | | |
| Component | SEESORB 107 | | | | | | | 1.2% | 1.2% |
| (f) | (λf = 354 nm) | | | | | | | | |
| (mass %) | Tinuvin 477 | | | | | | 1.2% | | |
| | (λf = 356 nm) | | | | | | | | |
| | Tinuvin 405 | | | | | 1.2% | | | |
| | (λf = 335 nm) | | | | | | | | |
| Surfactant | FP-1 | 0.1% | 0.1% | 0.1% | 0.1% | 0.1% | 0.1% | 0.1% | 0.1% |
| (mass %) | | | | | | | | | |
| Solvent | Methyl Ethyl | 40% | 40% | 40% | 40% | 40% | 40% | 40% | 40% |
| (mass %) | Ketone | | | | | | | | |
| | Methyl Isobutyl | 50% | 50% | 50% | 50% | 50% | 50% | 50% | 50% |
| | Ketone | | | | | | | | |
| | Methyl Acetate | 10% | 10% | 10% | 10% | 10% | 10% | 10% | 10% |

| | | | | | | | | |
|---|---|---|---|---|---|---|---|---|
| Remark | Ex. | Ex. | Ex. | Ex. | Ex. | Ex. | Ex. | Ex. |

| Composition for Forming | | | | | | |
|---|---|---|---|---|---|---|
| Hard Coat Layer | | A22 | A23 | A24 | A25 | A26 |
| Compound | 3,4-Epoxy- | 40.0% | 25.0% | 25.0% | 25.0% | 25.0% |
| (a) (mass %) | cyclohexyl-methyl | | | | | |
| | (Meth)acrylate | | | | | |
| Compound | DPHA | 38.7% | 54.9% | 53.7% | 54.9% | 53.7% |
| (b) (mass %) | | | | | | |
| Component | Irgacure 184 | 4.0% | 4.0% | 4.0% | 4.0% | 4.0% |
| (c) | (λc = 244 nm) | | | | | |
| (mass %) | | | | | | |
| Component | Cationic | 1.0% | 1.0% | 1.0% | 1.0% | 1.0% |
| (d) | Polymerization | | | | | |
| (mass %) | Initiator A | | | | | |
| | (λd = 280 nm) | | | | | |
| Component | ELECOM | 15.0% | 15.0% | 15.0% | 15.0% | 15.0% |
| (e) | V-8802 | | | | | |
| (mass %) | | | | | | |
| Component | SEESORB 107 | 1.2% | | 1.2% | | 1.2% |
| (f) | (λf = 354 nm) | | | | | |
| (mass %) | Tinuvin 477 | | | | | |
| | (λf = 356 nm) | | | | | |
| | Tinuvin 405 | | | | | |
| | (λf = 335 nm) | | | | | |
| Surfactant | FP-1 | 0.1% | 0.1% | 0.1% | 0.1% | 0.1% |
| (mass %) | | | | | | |
| Solvent | Methyl Ethyl | 40% | 40% | 40% | 40% | 40% |
| (mass %) | Ketone | | | | | |
| | Methyl Isobutyl | 50% | 50% | 50% | 50% | 50% |
| | Ketone | | | | | |
| | Methyl Acetate | 10% | 10% | 10% | 10% | 10% |

| | | | | | |
|---|---|---|---|---|---|
| Remark | Ex. | Ex. | Ex. | Ex. | Ex. |

TABLE 3

| Composition for Forming Hard Coat Layer | | B01 | B02 | B03 | B04 | B05 | B06 |
|---|---|---|---|---|---|---|---|
| Compound | 3,4-Epoxycyclohexylmethyl | | | | | | 98.9% |
| (a) (mass %) | (meth)acrylate | | | | | | |
| | Epoxy Polymer B | | | | | 20.0% | |
| Compound | DPHA | 23.8% | 23.8% | 69.9% | 94.9% | 74.9% | 0.0% |
| (b) (mass %) | PETA | 23.8% | 23.8% | | | | |
| | U-4HA | 47.5% | 47.5% | | | | |
| Component | Irgacure 184 (λc = 244 nm) | 4.8% | 4.8% | 4.0% | 4.0% | | |
| (c) (mass %) | Irgacure 127 (λc = 264 nm) | | | | | 4.0% | |
| Component | Cationic Polymerization Initiator A | | | 1.00% | 1.00% | 1.0% | 1.0% |
| (d) (mass %) | (λc = 280 nm) | | | | | | |
| Surfactant | FP-1 | 0.1% | 0.1% | 0.10% | 0.10% | 0.1% | 0.1% |
| (mass %) | | | | | | | |
| Others | Celloxide 2021P | | | 25% | | | |
| (mass %) | Glycidyl (Meth)acrylate | | | | 25% | | |
| Solvent | Methyl Ethyl Ketone | 100% | 100% | 40% | 40% | 40% | 40% |
| (mass %) | Methyl Isobutyl Ketone | | | 50% | 50% | 50% | 50% |
| | Methyl Acetate | | | 10% | 10% | 10% | 10% |

| | | | | | | |
|---|---|---|---|---|---|---|
| Remark | C. Ex. | C. Ex. | C. Ex. | C. Ex. | C. Ex. | C. Ex. |

Epoxy Polymer A: The Following Compound

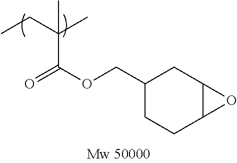

(Synthesis of Epoxy Polymer A)

Into a 300-ml 3-neck flask equipped with a stirrer, a thermometer, a reflux cooling tube, and a nitrogen gas introduction tube, 10.0 g of methyl ethyl ketone was placed, and the temperature was increased up to 80° C. Subsequently, a mixed solution composed of 19.63 g (0.1 mol) of Cyclomer M, 10.0 g of methyl ethyl ketone, and 0.23 g of “V-601” (manufactured by Wako Pure Chemical Industries, Ltd.) was added dropwise thereto at a constant rate for 6 hours until the dropwise addition was complete. After completion of the dropwise addition, stirring was continuously conducted for additionally 12 hours, the solvent was evaporated under reduced pressure, and the residue was dried at 80° C. under reduced pressure to obtain 24.20 g of Cyclomer M Polymer. The weight average molecular weight (Mw) of the polymer was 50,000 (calculated in terms of polystyrene by gel permeation chromatography (GPC), and the columns used was TSKgel SuperHZM-H, TSKgel SuperHZ4000, and TSKgel SuperHZ200 (manufactured by TOSOH CORPORATION)).

Epoxy Polymer B: The Following Compound

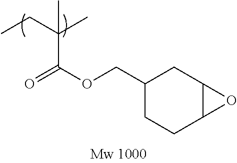

(Synthesis of Epoxy Polymer B)

This method is the same as the method of synthesizing Epoxy Polymer A, except that the weight of “V-601” (manufactured by Wako Pure Chemical Industries, Ltd.) was changed into 23.26 g, and Epoxy Polymer B having a weight average molecular weight (Mw) of the polymer of 1,000 was obtained.

Epoxy Polymer C: The Following Compound

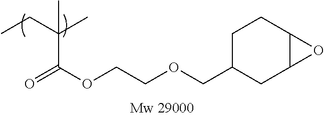

(Synthesis of Epoxy Polymer C)

Into a 300-ml 3-neck flask equipped with a stirrer, a thermometer, a reflux cooling tube, and a nitrogen gas introduction tube, 10.0 g of methyl ethyl ketone was placed, and the temperature was increased up to 80° C. Subsequently, a mixed solution composed of 23.93 g (0.1 mol) of N-(2-(7-oxabicyclo[4.1.0]heptan-3-ylmethoxy)ethyl)methacrylamide, 10.0 g of methyl ethyl ketone, and 0.69 g of “V-601” (manufactured by Wako Pure Chemical Industries, Ltd.) was added dropwise thereto at a constant rate for 6 hours until the dropwise addition was complete. After completion of the dropwise addition, stirring was continuously conducted for additionally 12 hours, the solvent was evaporated under reduced pressure, and the residue was dried at 80° C. under reduced pressure to obtain 21.70 g of Compound 5. The weight average molecular weight (Mw) of the polymer was 29,000 (calculated in terms of polystyrene by gel permeation chromatography (GPC), and the columns used was TSKgel SuperHZM-H, TSKgel SuperHZ4000, and TSKgel SuperHZ200 (manufactured by TOSOH CORPORATION)).
3,4-Epoxycyclohexylmethyl (meth)acrylate (Cyclomer M100 (manufactured by Daicel Corporation) a compound having an alicyclic epoxy group and an ethylenically unsaturated double bond group in the molecule and a molecular weight of 196)
3,4-Epoxycyclohexylbutyl (meth)acrylate (a compound having an alicyclic epoxy group and an ethylenically unsaturated double bond group in the molecule and a molecular weight of 238)
DPHA: KAYARD DPHA a mixture of dipentaerythritol pentaacrylate and dipentaerythritol hexaacrylate (manufactured by Nippon Kayaku Co. Ltd.)
PETA: KAYARD PET-30 a mixture of dipentaerythritol pentaacrylate and dipentaerythritol triacrylate (manufactured by Nippon Kayaku Co., Ltd.)
U-4HA: NK Oligo U-4HA Urethane Acrylate (manufactured by Shin-Nakamura Chemical Co., Ltd.)

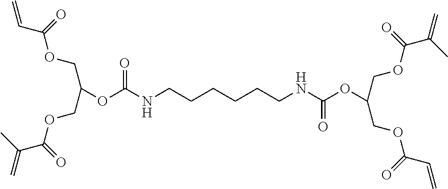 [SMILES: C=CC(=O)OCC(COC(=O)C(=C)C)OC(=O)NCCCCCCNC(=O)OC(COC(=O)C=C)COC(=O)C(=C)C]

Irgacure907: Radical polymerization initiator (manufactured by BASF)
Irgacure184: Radical polymerization initiator (manufactured by BASF)
Irgacure127: Radical polymerization initiator (manufactured by BASF)
Irgacure270: Sulfonium salt-based cationic polymerization initiator (manufactured by BASF)
WPI-170: Iodonium salt-based cationic polymerization initiator (manufactured by Wako Pure Chemical Industries, Ltd.)

Cationic Polymerization A: Iodonium Salt-Based Cationic Polymerization Initiator (Following Compound)

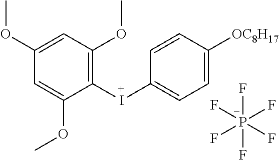

ELECOM V-8802: Average particle diameter 12 nm, including a polymerizable group, an MiBK (methyl isobutyl ketone) dispersion of spherical silica particles having a solid content of 40 mass % (manufactured by JGC Corporation)
MiBK-ST: Average particle diameter 10 nm to 20 nm, an MiBK dispersion of silica particles, to which no reactive group is imparted, having a solid content of 30 mass % (manufactured by Nissan Chemical Industries, Ltd.)

SEESORB107: manufactured by Shipro Kasei Kaisha Ltd.

Tinuvin477: manufactured by BASF

Tinuvin405: manufactured by BASF
FP-1: Following nitrogen-containing compound

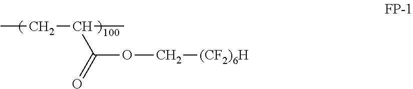

Celloxide 2021P: 3′,4′-epoxycyclohexylmethyl 3,4-epoxycyclohexane carboxylate (manufactured by Daicel Corporation)

Glycidyl methacrylate (manufactured by KYOEISHA CHEMICAL Co., Ltd.)

(Application and Formation of Hard Coat Layer)

Triacetyl cellulose (TAC) films having a thickness of 25 μm and 15 μm were each unwound from the form of roll, and Hard coat films S01 to S26 and T01 to T06 were prepared thereon by using Compositions for forming a hard coat layer A01 to A26 and B01 to B06 to adjust film thicknesses of the hard coat layers to the thicknesses described in the following Tables 4 to 6.

Specifically, each coating liquid was applied on the triacetyl cellulose films under conditions of a conveying speed of 30 m/min by the die coat method using a slot die described in Example 1 of Japanese Patent Laid-Open Publication No. 2006-122889 and dried at 50° C. for 60 seconds, and then a 160 W/cm air-cooled metal halide lamp (manufactured by Eye Graphics Co., Ltd.) was additionally used at an oxygen concentration of about 0.1 vol % while purging with nitrogen to irradiate ultraviolet rays at an luminance of 400 mW/cm² and an irradiation dose of 500 mJ/cm² thereon to cure a coating layer and form a hard coat layer, and then hard coat layer was unwound.

Further, when the polarizing plate protective films of S01 to S09 and T01 to T05 were prepared, ultraviolet rays were irradiated thereon while wrapping the films with a backup roll warmed to 30° C., and UV rays at an irradiation dose of 500 mJ/cm² were irradiated thereon such that the film surface temperature was maintained at 40° C. or less.

When a polarizing plate protective film of S10 was prepared, ultraviolet rays were irradiated thereon at an irradiation dose of 500 mJ/cm² while wrapping the film with a backup roll warmed to 60° C.

When the polarizing plate protective films of S11 to S26 were prepared, ultraviolet rays were irradiated thereon at an irradiation dose of 50 mJ/cm² while wrapping the film with a backup roll warmed to 30° C., and then ultraviolet rays were irradiated thereon at an irradiation dose of 450 mJ/cm² while wrapping the roll with a backup roll warmed to 60° C.

In addition, with respect to the polarizing plate protective films of S23 and S24, a cellulose acylate support prepared by the following method was used to apply and form a hard coat layer.

The cellulose acylate supports of S1 to S22 and T01 to T05 were prepared in the same manner as in the cellulose acylate films of S23 and S24, except that Compound A-1 was excluded.

(Preparation of Core Layer Cellulose Acylate Dope)

Into a mixing tank, the following composition was introduced and stirred, and each component was dissolved to adjust a cellulose acetate solution.

| | |
|---|---|
| Cellulose acetate with an acetyl substitution | 100 parts by mass |
| degree of 2.88 and a weight average molecular | |
| weight of 260,000 | |
| Phthalic acid ester oligomer A | 10 parts by mass |
| Compound (A1) | 4 parts by mass |
| UV absorber (compound with the following | 2.7 parts by mass |
| structural formula, manufactured by BASF) | |
| TINUVIN123 (HA-1, manufactured by BASF) | 0.18 mass by mass |
| Tekuran DO (N-alkenyl propylenediamine triacetic | 0.02 part by mass |
| acid, manufactured by Nagase ChemteX | |
| Corporation) | |
| Methylene chloride (First solvent) | 430 parts by mass |
| Methanol (Second solvent) | 64 parts by mass |

Phthalic acid ester oligomer A; Mw: 750 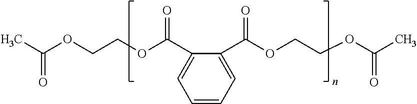
Compound (A-1) 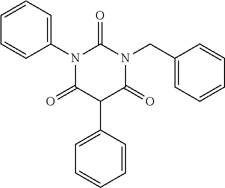 [SMILES: O=C1C(c2ccccc2)C(=O)N(c2ccccc2)C(=O)N1Cc1ccccc1]
UV Absorber

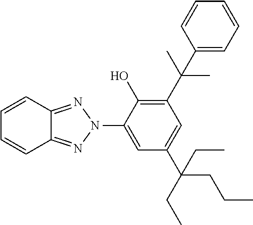 [SMILES: CCCC(CC)(CC)c1cc(-n2nc3ccccc3n2)c(O)c(C(C)(C)c2ccccc2)c1]

(Preparation of Outer Layer Cellulose Acylate Dope)

10 parts by mass of the following matting solution was added to 90 parts by mass of the aforementioned core layer cellulose acylate dope to adjust an outer layer cellulose acetate solution.

| | | |
|---|---|---|
| Silica particles with an average particle | 2 | parts by mass |
| size of 20 nm (manufactured by AEROSIL | | |
| R972, NIPPON AEROSIL CO., LTD.) | | |
| Methylene chloride (First solvent) | 76 | parts by mass |
| Methanol (Second solvent) | 11 | parts by mass |
| Core layer cellulose acylate dope | 1 | part by mass |

(Preparation of Cellulose Acylate Film)

The core layer cellulose acylate dope and an outer layer cellulose acylate dope at both sides thereof were simultaneously cast in three layers on a drum at 20° C. from a casting outlet. The cast films were peeled in a state of a solvent content ratio of approximately 20 mass %, both ends of the film in the width direction were fixed with a tenter clip, and the film was dried in a state of a residual solvent of 3% to 15% while being stretched by 1.18 times in a lateral direction. Thereafter, the film was further dried by being conveyed between rolls of a heat treatment device to prepare a cellulose acylate film having a thickness of 25 μm.

The cellulose acylate film having a thickness of 15 μm was prepared by using a dope which is the same as the 25 μm-cellulose acylate film, and adjusting the casting amount of the dope such that the film thickness after drying became 15 μm.

Furthermore, with respect to the polarizing plate protective films of S25 and S26, a cellulose acylate support prepared by the following method was used to apply and form a hard coat layer.

(Preparation of Cellulose Ester Solution for Air Layer)

Into a mixing tank, the following composition was introduced and stirred while being heated, and each component was dissolved to prepare a cellulose ester solution for an air layer.

Composition of Cellulose Ester Solution for Air Layer

| | |
|---|---|
| Cellulose ester (an acetyl substitution | 100 parts by mass |
| degree of 2.86 and a weight average molecular | |
| weight of 260,000) | |
| Sugar ester compound of Formula (11) | 3 parts by mass |
| Sugar ester compound of Formula (12) | 1 part by mass |
| Additive of Formula (13) | 2.4 parts by mass |
| Additive of Formula (14) | 0.022 parts by mass |
| Additive of Formula (15) | 0.012 parts by mass |
| Dispersion of silica particles (average particle | 0.03 part by mass |
| diameter 16 nm) “AEROSILR972”, manufactured | |
| by NIPPON AEROSIL CO., LTD. | |
| Methylene chloride | 398 parts by mass |
| Methanol | 67 parts by mass |
| Butanol | 3 parts by mass |

Formula (11) 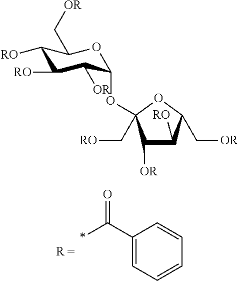
Formula (12) 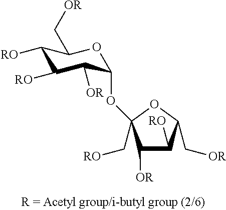
Formula (13) 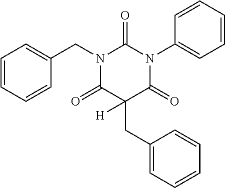 [SMILES: O=C1C(Cc2ccccc2)C(=O)N(c2ccccc2)C(=O)N1Cc1ccccc1]
Formula (14) 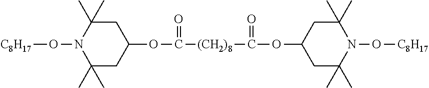
Formula (15)

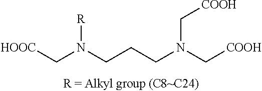

(Preparation of Cellulose Ester Solution for Air Layer)

Into a mixing tank, the following composition was introduced and stirred while being heated, and each component was dissolved to prepare a cellulose ester solution for a drum layer.

Composition of Cellulose Ester Solution for Drum Layer

| | | |
|---|---|---|
| Cellulose ester (an acetyl substitution degree | 100 | parts by mass |
| of 2.86 and a weight average molecular | | |
| weight of 260,000) | | |
| Sugar ester compound of Formula (11) | 3 | part by mass |
| Sugar ester compound of Formula (12) | 1 | part by mass |
| Additive of Formula (13) | 2.4 | parts by mass |
| Additive of Formula (14) | 0.022 | parts by mass |
| Additive of Formula (15) | 0.012 | parts by mass |
| Dispersion of silica particles (average particle | 0.09 | parts by mass |
| diameter 16 nm) “AEROSILR972”, manufactured | | |
| by NIPPON AEROSIL CO., LTD. | | |
| Methylene chloride | 364 | parts by mass |
| Methanol | 80 | parts by mass |
| Butanol | 4 | parts by mass |

(Preparation of Cellulose Ester Solution for Core Layer)

Into a mixing tank, the following composition was introduced and stirred while being heated, and each component was dissolved to prepare a cellulose ester solution for a core layer.

(Composition of Cellulose Ester Solution for Core Layer)

| | |
|---|---|
| Cellulose ester (an acetyl substitution | 100 parts by mass |
| degree of 2.86 and a weight average molecular | |
| weight of 260,000) | |
| Sugar ester compound of Formula (11) | 3 parts by mass |
| Sugar ester compound of Formula (12) | 1 part by mass |
| Additive of Formula (13) | 6 parts by mass |
| Additive of Formula (14) | 0.054 parts by mass |
| Additive of Formula (15) | 0.03 parts by mass |
| UV absorber of Formula (16) | 2.4 parts by mass |
| Methylene chloride | 298 parts by mass |
| Methanol | 65 parts by mass |
| Butanol | 3 parts by mass |

Formula (16)

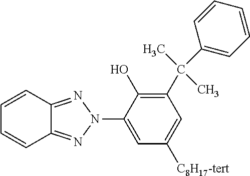

(Film Formation by Co-Casting)

As a casting die, a device, which was equipped with a feed block adjusted for co-casting and thus could mold a film with a 3 layer structure, was used. The cellulose ester solution for an air layer, a cellulose ester solution for a core layer, and a cellulose ester solution for a drum layer were co-cast on a drum cooled to −7° C. from a casting outlet. In this case, the flow rate of each dope was adjusted such that the ratio of the thicknesses air layer/intermediate layer/drum layer became 5/53/2.

The films were cast on a specular stainless support which was a drum having a diameter of 3 m. A drying wind at 34° C. was applied at 270 m³/min on the drum. Moreover, immediately before 50 cm from the end point portion of the casting portion, the cellulose ester film coming while being cast and rotated was peeled from the drum, and then both ends thereof were clipped with a pin tenter. When peeled, the film was stretched in a conveying direction (longitudinal direction) by 5%.

The cellulose ester web held with the pin tenter was conveyed to a drying zone. A drying wing at 45° C. was sent thereto in the initial drying, and subsequently, the cellulose ester web was dried at 100° C. for 5 minutes. In this case, the cellulose ester web was conveyed in the width direction at a magnification of 90/%.

The web was discharged from the pin tenter, and then the portion held by the pin tenter was continuously cut, and dried at 145° C. for 10 minutes while a tension of 210 N was applied thereon in the conveying direction. Furthermore, the end in the width direction was continuously cut such that the web had a desired width, and unevenness with a width of 15 mm and a height of 10 μm was attached to the both ends of the web in the width direction to prepare a film having a film thickness of 40 μm.

TABLE 4

| | | Sample No. | | | | | | | | | | | | | | | |
|---|---|---|---|---|---|---|---|---|---|---|---|---|---|---|---|---|---|
| | | S01 | | S02 | | S03 | | S04 | | S05 | | S06 | | S07 | | S08 | |
| | | Composition for forming hard coat layer No. | | | | | | | | | | | | | | | |
| | | A01 | | A02 | | A03 | | A04 | | A05 | | A06 | | A07 | | A08 | |
| Layer | Support | 25 | μm | 25 | μm | 25 | μm | 25 | μm | 25 | μm | 25 | μm | 25 | μm | 25 | μm |
| Con- | | TAC | | TAC | | TAC | | TAC | | TAC | | TAC | | TAC | | TAC | |
| figuration | Hard coat | 7.0 | μm | 7.0 | μm | 7.0 | μm | 7.0 | μm | 7.0 | μm | 7.0 | μm | 7.0 | μm | 7.0 | μm |
| | layer | | | | | | | | | | | | | | | | |
| | thickness | | | | | | | | | | | | | | | | |
| UV | Temperature | 30 | | 30 | | 30 | | 30 | | 30 | | 30 | | 30 | | 30 | |
| Curing | (° C.) | | | | | | | | | | | | | | | | |
| Con- | UV irradiation | 500 | | 500 | | 500 | | 500 | | 500 | | 500 | | 500 | | 500 | |
| dition | dose (mJ/cm²) | | | | | | | | | | | | | | | | |
| | Temperature | | | | | | | | | | | | | | | | |
| | (° C.) | | | | | | | | | | | | | | | | |
| | UV irradiation | | | | | | | | | | | | | | | | |
| | dose (mJ/cm²) | | | | | | | | | | | | | | | | |
| Eval- | λd-λc [nm] | 16 | | 16 | | 16 | | 16 | | 16 | | 16 | | 16 | | 16 | |
| uation | λf-λd [nm] | — | | — | | — | | — | | — | | — | | — | | — | |
| Result | Water vapor | 290 | | 290 | | 295 | | 300 | | 230 | | 280 | | 300 | | 245 | |
| | transmission | | | | | | | | | | | | | | | | |
| | rate | | | | | | | | | | | | | | | | |
| | WVTR_{A} | | | | | | | | | | | | | | | | |
| | Water vapor | 463 | | 463 | | 471 | | 492 | | 375 | | 418 | | 500 | | 368 | |
| | transmission | | | | | | | | | | | | | | | | |
| | rate | | | | | | | | | | | | | | | | |
| | WVTR_{B} | | | | | | | | | | | | | | | | |
| | WVTR_{A}/ | 0.63 | | 0.63 | | 0.63 | | 0.61 | | 0.61 | | 0.67 | | 0.60 | | 0.67 | |
| | WVTR_{B} | | | | | | | | | | | | | | | | |
| | Pencil | 3 | H | 3 | H | 3 | H | 3 | H | 4 | H | 3 | H | 3 | H | 4 | H |

| hardness | | | | | | | | | | | | | |
|---|---|---|---|---|---|---|---|---|---|---|---|---|---|
| Polarizing | 9.6% | 9.6% | 9.6% | 9.9% | | 8.6% | | 7.5% | | 10.0% | | 7.4% | |
| plate | | | | | | | | | | | | | |
| durability | | | | | | | | | | | | | |
| (Wet heat | | | | | | | | | | | | | |
| resistance) | | | | | | | | | | | | | |
| Film | 20% | 20% | 20% | 20% | | 20% | | 20% | | 20% | | 20% | |
| transmittance | | | | | | | | | | | | | |
| (380 nm) | | | | | | | | | | | | | |
| Remark | Ex. | Ex. | Ex. | Ex. | | Ex. | | Ex. | | Ex. | | Ex. | |
| | | | | Sample No. | | | | | | | | | |
| | | | | S09 | | S10 | | S11 | | S12 | | S13 | |
| | | | | Composition for forming hard coat layer No. | | | | | | | | | |
| | | | | A09 | | A10 | | A11 | | A12 | | A13 | |
| | | Layer | Support | 25 | μm | 25 | μm | 25 | μm | 25 | μm | 25 | μm |
| | | Con- | | TAC | | TAC | | TAC | | TAC | | TAC | |
| | | figuration | Hard coat | 7.0 | μm | 7.0 | μm | 7.0 | μm | 7.0 | μm | 7.0 | μm |
| | | | layer | | | | | | | | | | |
| | | | thickness | | | | | | | | | | |
| | | UV | Temperature | 30 | | 60 | | 30 | | 30 | | 30 | |
| | | Curing | (° C.) | | | | | | | | | | |
| | | Con- | UV irradiation | 500 | | 500 | | 50 | | 50 | | 50 | |
| | | dition | dose (mJ/cm²) | | | | | | | | | | |
| | | | Temperature | | | | | 60 | | 60 | | 60 | |
| | | | (° C.) | | | | | | | | | | |
| | | | UV irradiation | | | | | 450 | | 450 | | 450 | |
| | | | dose (mJ/cm²) | | | | | | | | | | |
| | | Eval- | λd-λc [nm] | 36 | | 7 | | 78 | | −27 | | 36 | |
| | | uation | λf-λd [nm] | — | | — | | — | | — | | — | |
| | | Result | Water vapor | 210 | | 255 | | 215 | | 285 | | 220 | |
| | | | transmission | | | | | | | | | | |
| | | | rate | | | | | | | | | | |
| | | | WVTR_{A} | | | | | | | | | | |
| | | | Water vapor | 288 | | 399 | | 295 | | 475 | | 351 | |
| | | | transmission | | | | | | | | | | |
| | | | rate | | | | | | | | | | |
| | | | WVTR_{B} | | | | | | | | | | |
| | | | WVTR_{A}/ | 0.73 | | 0.64 | | 0.73 | | 0.60 | | 0.63 | |
| | | | WVTR_{B} | | | | | | | | | | |
| | | | Pencil | 4 | H | 4 | H | 4 | H | 3 | H | 3 | H |

| | | | | | |
|---|---|---|---|---|---|
| hardness | | | | | |
| Polarizing | 6.0% | 7.9% | 6.2% | 10.0% | 8.2% |
| plate | | | | | |
| durability | | | | | |
| (Wet heat | | | | | |
| resistance) | | | | | |
| Film | 20% | 20% | 20% | 20% | 20% |
| transmittance | | | | | |
| (380 nm) | | | | | |
| Remark | Ex. | Ex. | Ex. | Ex. | Ex. |

TABLE 5

| | | Sample No. | | | | | | | | | | | | | | | |
|---|---|---|---|---|---|---|---|---|---|---|---|---|---|---|---|---|---|
| | | S14 | | S15 | | S16 | | S17 | | S18 | | S19 | | S20 | | S21 | |
| | | Composition for forming hard coat layer No. | | | | | | | | | | | | | | | |
| | | A14 | | A15 | | A16 | | A17 | | A18 | | A19 | | A20 | | A21 | |
| Layer | Support | 25 | μm | 25 | μm | 25 | μm | 15 | μm | 25 | μm | 25 | μm | 25 | μm | 25 | μm |
| Configuration | | TAC | | TAC | | TAC | | TAC | | TAC | | TAC | | TAC | | TAC | |
| | Hard coat | 7.0 | μm | 7.0 | μm | 3.5 | μm | 7.0 | μm | 7.0 | μm | 7.0 | μm | 7.0 | μm | 7.0 | μm |
| | layer thickness | | | | | | | | | | | | | | | | |
| UV Curing | Temperature (° C.) | 30 | | 30 | | 30 | | 30 | | 30 | | 30 | | 30 | | 30 | |
| Condition | UV irradiation | 50 | | 50 | | 50 | | 50 | | 50 | | 50 | | 50 | | 50 | |
| | dose (mJ/cm²) | | | | | | | | | | | | | | | | |
| | Temperature (° C.) | 60 | | 60 | | 60 | | 60 | | 60 | | 60 | | 60 | | 60 | |
| | UV irradiation | 450 | | 450 | | 450 | | 450 | | 450 | | 450 | | 450 | | 450 | |
| | dose (mJ/cm²) | | | | | | | | | | | | | | | | |
| Evaluation | λd-λc [nm] | 36 | | 36 | | 36 | | 36 | | 36 | | 36 | | 36 | | 36 | |
| Result | λf-λd [nm] | — | | — | | — | | — | | 55 | | 76 | | 74 | | 74 | |
| | Water vapor | 215 | | 198 | | 280 | | 230 | | 240 | | 220 | | 204 | | 260 | |
| | transmission rate | | | | | | | | | | | | | | | | |
| | WVTR_{A} | | | | | | | | | | | | | | | | |
| | Water vapor | 284 | | 237 | | 358 | | 294 | | 361 | | 301 | | 252 | | 338 | |
| | transmission rate | | | | | | | | | | | | | | | | |
| | WVTR_{B} | | | | | | | | | | | | | | | | |
| | WVTR_{A}/WVTR_{B} | 0.76 | | 0.83 | | 0.78 | | 0.78 | | 0.67 | | 0.73 | | 0.81 | | 0.77 | |
| | Pencil hardness | 4 | H | 4 | H | 3 | H | 3 | H | 3 | H | 4 | H | 4 | H | 4 | H |

| | Polarising plate | 5.7% | 2.5% | 5.6% | 3.6% | | 7.4% | | 6.3% | | 3.0% | | 4.0% | |
|---|---|---|---|---|---|---|---|---|---|---|---|---|---|---|
| | durability | | | | | | | | | | | | | |
| | (Wet heat resistance) | | | | | | | | | | | | | |
| | Film transmittance | 20% | 20% | 20% | 20% | | 12% | | 11% | | 11% | | 11% | |
| | (380 nm) | | | | | | | | | | | | | |
| Remark | | Ex. | Ex. | Ex. | Ex. | | Ex. | | Ex. | | Ex. | | Ex. | |
| | | | | | Sample No. | | | | | | | | | |
| | | | | | S22 | | S23 | | S24 | | S25 | | S26 | |
| | | | | | Composition for forming hard coat layer No. | | | | | | | | | |
| | | | | | A22 | | A23 | | A24 | | A25 | | A26 | |
| | | | Layer | Support | 25 | μm | 25 | μm | 25 | μm | 40 | μm | 40 | μm |
| | | | Configuration | | TAC | | TAC | | TAC | | TAC | | TAC | |
| | | | | Hard coat | 7.0 | μm | 7.0 | μm | 7.0 | μm | 7.0 | μm | 7.0 | μm |
| | | | | layer thickness | | | | | | | | | | |
| | | | UV Curing | Temperature (° C.) | 30 | | 30 | | 30 | | 30 | | 30 | |
| | | | Condition | UV irradiation | 50 | | 50 | | 50 | | 50 | | 50 | |
| | | | | dose (mJ/cm²) | | | | | | | | | | |
| | | | | Temperature (° C.) | 60 | | 60 | | 60 | | 60 | | 60 | |
| | | | | UV irradiation | 450 | | 450 | | 450 | | 450 | | 450 | |
| | | | | dose (mJ/cm²) | | | | | | | | | | |
| | | | Evaluation | λd-λc [nm] | 36 | | 36 | | 36 | | 36 | | 36 | |
| | | | Result | λf-λd [nm] | 74 | | — | | 74 | | — | | 74 | |
| | | | | Water vapor | 200 | | 198 | | 204 | | 170 | | 180 | |
| | | | | transmission rate | | | | | | | | | | |
| | | | | WVTR_{A} | | | | | | | | | | |
| | | | | Water vapor | 295 | | 237 | | 252 | | 204 | | 223 | |
| | | | | transmission rate | | | | | | | | | | |
| | | | | WVTR_{B} | | | | | | | | | | |
| | | | | WVTR_{A}/WVTR_{B} | 0.68 | | 0.83 | | 0.81 | | 0.83 | | 0.81 | |
| | | | | Pencil hardness | 3 | H | 4 | H | 4 | H | 4 | H | 4 | H |

| | | | | | | |
|---|---|---|---|---|---|---|
| | Polarising plate | 6.5% | 1.9% | 2.4% | 1.9% | 2.4% |
| | durability | | | | | |
| | (Wet heat resistance) | | | | | |
| | Film transmittance | 11% | 20% | 11% | 20% | 11% |
| | (380 nm) | | | | | |
| Remark | | Ex. | Ex. | Ex. | Ex. | Ex. |

TABLE 6

| | | Sample No. | | | | | | | | | | | |
|---|---|---|---|---|---|---|---|---|---|---|---|---|---|
| | | T01 | | T02 | | T03 | | T04 | | T05 | | T05 | |
| | | Composition for forming hard coat layer No. | | | | | | | | | | | |
| | | B01 | | B02 | | B03 | | B04 | | B05 | | B06 | |
| Layer | Support | 25 | μm | 25 | μm | 25 | μm | 25 | μm | 25 | μm | 25 | μm |
| Configuration | | TAC | | TAC | | TAC | | TAC | | TAC | | TAC | |
| | Hard coat layer thickness | 5.0 | μm | 12 | μm | 7.0 | μm | 7.0 | μm | 7.0 | μm | 7.0 | μm |

| UV Curing | Temperature (° C.) | 30 | | 30 | | 30 | | 30 | | 30 | | 30 |
|---|---|---|---|---|---|---|---|---|---|---|---|---|
| Condition | UV irradiation dose (mJ/cm²) | 500 | | 500 | | 500 | | 500 | | 500 | | 500 |
| | Temperature (° C.) | | | | | | | | | | | |
| | UV irradiation dose (mJ/cm²) | | | | | | | | | | | |
| Evaluation) | λd-λc [nm] | — | | — | | 36 | | 36 | | 16 | | 16 |
| Result | λf-λd [nm] | — | | — | | — | | — | | — | | — |
| | Water vapor transmission rate | 450 | | 350 | | 200 | | 400 | | 295 | | 400 |
| | WVTR_{A} | | | | | | | | | | | |
| | Water vapor transmission rate | 714 | | 556 | | 444 | | 870 | | 518 | | 1000 |
| | WVTR_{B} | | | | | | | | | | | |
| | WVTR_{A}/WVTR_{B} | 0.63 | | 0.63 | | 0.45 | | 0.46 | | 0.57 | | 0.40 |
| | Pencil hardness | 3 | H | 3 | H | 3 | H | 3 | H | 3 | H | H |

| | | | | | | |
|---|---|---|---|---|---|---|
| Polarizing plate durability | 21.2% | 18.0% | 20.1% | 25.3% | 162% | 30.0% |
| (Wet heat resistance) | | | | | | |
| Film transmittance (380 nm) | 20% | 20% | 20% | 20% | 20% | 20% |
| Remark | C. Ex. | C. Ex. | C. Ex. | C. Ex. | C. Ex. | C. Ex. |

The prepared polarizing plate protective film was evaluated by the following evaluation method.

(Film Thickness of Hard Coat Layer)

The film thickness of the hard coat layer was calculated by measuring the film thickness of the prepared polarizing plate protective film by a film thickness meter, and subtracting the thickness of the support (cellulose acylate film) measured by the same method therefrom.

(Water Vapor Transmission Rate WVTR_{A})

The polarizing plate protective film samples 70 mmφ in the Examples and the Comparative Examples were each humidity controlled at a temperature of 40° C. and a relative humidity of 90% for 24 hours, and the water vapor transmission rate was measured by the method described in the JIS Z-0208 (1976).

(Water Vapor Transmission Rate WVTR_{B})

The polarizing plate protective film samples 70 mmφ in the Examples and the Comparative Examples were each humidity controlled at a temperature of 85° C. and a relative humidity of 90%, and then, each film was set in the cup, humidity controlled at a temperature of 40° C. and a relative humidity of 90% for 24 hours, and the water vapor transmission rate was measured by the method described in the JIS Z-0208 (1976).

(Pencil Hardness)

The pencil hardness evaluation described in the JIS K 5600-5-4 (1999) was conducted. The polarizing plate protective film was exposed at a temperature of 25° C. and a humidity of 60% RH for 2 hours, and then was determined at a load of 4.9 N by using a pencil for a test regulated by the JIS S 6006 (2007).

(Film Transmittance)

The transmittance of the polarizing plate protective film was measured by a spectrophotometer UV-3150 manufactured by Shimadzu Corporation, and a film transmittance at a wavelength of 380 nm was obtained.

(Preparation of Polarizing Plate)

1] Saponification of Film

After the polarizing plate protective films prepared in the Examples and the Comparative Examples and the above-described cellulose film having a thickness of 25 pun were immersed in an aqueous sodium hydroxide solution (saponification solution) temperature-controlled at 37° C. and a concentration of 4.5 mol/L for 1 minute, the films were washed, and then immersed in an aqueous sulfuric acid solution at a concentration of 0.05 mol/L for 30 seconds, and then allowed to pass through a washing bath. And then, dehydration by an air knife was repeated three times to remove water, and then the film was stayed for drying in a drying zone at 70° C. for 15 seconds to prepare a saponification-treated film.

2] Preparation of Polarizer

A polarizer having a thickness of 7 μm was prepared by imparting a circumferential speed difference between two pairs of nip rolls and stretching in the longitudinal direction thereof in accordance with Example 1 of Japanese Patent Laid-Open Publication No. 2001-141926.

3] Adhesion

A polarizing plate was prepared by selecting the polarizing film thus obtained and two sheets of the saponification-treated films, sandwiching the polarizing film therebetween, and then adhering the films using a 3% aqueous solution of PVA (PVA-117H manufactured by KURARAY CO., LTD.) as an adhesive by roll-to-roll such that the polarizing axis and the longitudinal direction of the films are orthogonal to each other. Here, one film of the polarizer was a saponified film selected from the group of films in the Examples or the Comparative Examples, and the other film was a film obtained by subjecting a cellulose acylate film having a thickness of 25 μm to saponification.

4] Evaluation of Durability of Polarizing Plate (Wet Heat Resistance)

For the polarizing plate as prepared above, two sets of samples (about 5 cm×5 cm) were prepared, in which a surface opposite to the surface of each of the polarizing plate protective films in the Examples and the Comparative Examples was adhered onto a glass plate using an adhesive. The samples were disposed in a crossed nicol, and the polarization degree was measured using VAP-7070 (manufactured by JASCO CORPORATION).

Thereafter, the polarization degree after the sample was stored under environments of 85° C. and a relative humidity of 85% for 24 hours was measured by the method. The evaluation value of the durability of the polarizing plate is defined as follows.

Evaluation Value of Durability of Polarizing Plate;

[Polarization degree before elapse of time (%)−Polarization degree after elapse of time (%)]

[Preparation of Liquid Crystal Display]

A polarizing plate on the surface side of a commercially available IPS-mode liquid crystal television set (42LS5600 manufactured by LG Electronics Corp.) was peeled off, and each of the polarizing plates in the Examples or the Comparatives prepared above was adhered to the front side so as to make the hard coat layer become the uppermost surface, such that the absorption axis of the polarizing plate on the front side was disposed in a longitudinal direction (crosswise direction). The thickness of glass used in the liquid crystal cell was 0.5 mm.

By doing this, a liquid crystal display device was obtained.

The polarizing plate protective films prepared and the evaluation results of the polarizing plates using the polarizing plate protective films are shown in the aforementioned Tables 4 to 6. It can be seen that the polarizing plate protective films in the Examples have higher pencil hardness and better low-water vapor permeability than those in the Comparative Examples.

Further, it can be seen that compared to Polarizing Plate Protective Film S01 or S13, Polarizing Plate Protective Film S08, to which crosslinkable inorganic particles were added, has high pencil hardness, and is excellent in low-water vapor permeability and polarizing plate durability.

In addition, it can be seen that compared to Polarizing Plate Protective Films S08, S10, and S12, Polarizing Plate Protective Film S09 or S011, in which the absorption wavelength λd-λc of the radical polymerization initiator and the cationic polymerization initiator is 30 nm or more, is excellent in low-water vapor permeability and polarizing plate durability.

Furthermore, in S18 to S20 to which an UV absorber was added, it can be confirmed that S19 and S20, which the λd-λc is 50 nm or more, are excellent in pencil hardness, low-water vapor permeability, and polarizing plate durability.

Further, it can be confirmed that S23 to S26 containing Compound represented by Formula I in the cellulose acylate support could further improve the polarizing plate durability.

In addition, it can be seen that compared to S09 and S14, S15, which was UV-irradiated at 50 mJ/cm² while being wrapped with a backup roll warmed to 30° C., and then UV-irradiated at 450 mJ/cm² while being wrapped with a backup roll warmed to 60° C., could further improve low-water vapor permeability and polarizing plate durability.

What is claimed is:

1. A polarizing plate protective film comprising: a hard coat layer having a film thickness of 3 μm to 10 μm on at least one surface of a cellulose acylate film having a thickness of 15 μm to 40 μm,
wherein the hard coat layer is a layer formed by curing a composition for forming a hard coat layer containing:
(a) a compound having at least one alicyclic epoxy group in molecule
(b) a compound having three or more ethylenically unsaturated double bond groups in molecule
(c) a radical polymerization initiator
(d) a cationic polymerization initiator, and
the polarizing plate protective film has a WVTR_{A} of 300 g/m²/day or less and a ratio WVTR_{A}/WVTR_{B} of 0.6 to 1.0 when a water vapor transmission rate under environments of a temperature of 40° C. and a relative humidity of 90% is defined as WVTR_{A} and a water vapor transmission rate under environments of a temperature of 40° C. and a relative humidity of 90% after being exposed to the environments of a temperature of 85° C. and a relative humidity of 85% for 24 hours is defined as WVTR_{B}.

2. The polarizing plate protective film of claim 1,
wherein the WVTR_{A} is less than 230 g/m²/day and the ratio WVTR_{A}/WVTR_{B} is 0.7 to 1.0.

3. The polarizing plate protective film of claim 1,
wherein the compound (a) is represented by Formula (1) below, the compound (a) having an alicyclic epoxy group and an ethylenically unsaturated double bond group in molecule, and a molecular weight of 300 or less: 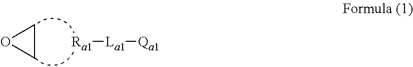
wherein in Formula (1), Rₐ₁ represents a monocyclic hydrocarbon, or a crosslinked hydrocarbon,
Lₐ₁ represents a single bond or a divalent linking group, and
Qₐ₁ represents an ethylenically unsaturated double bond group.

4. The polarizing plate protective film of claim 1,
wherein the compound (a) includes a repeating unit represented by Formula (2) below and has a weight average molecular weight of 1,500 or more: 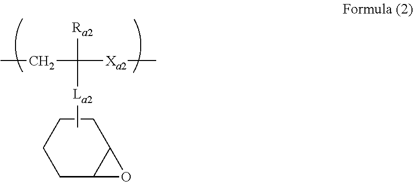
wherein in Formula (2), Rₐ₂ represents a hydrogen atom or a methyl group,
Xₐ₂ represents a single bond, or an oxygen atom, an alkylene group which optionally has a substituent, an arylene group which optionally has a substituent, an aralkylene group which optionally has a substituent, an ester bond, a carbonyl bond, —NH—, or a linking group composed of a combination thereof, and
Lₐ₂ represents a single bond, or an alkylene group which optionally has a substituent, an arylene group which optionally has a substituent, an aralkylene group which optionally has a substituent, an ester bond, an ether bond, a carbonyl bond, —NH—, or a linking group composed of a combination thereof.

5. The polarizing plate protective film of claim 1,
wherein a content of the compound (a) is 10 mass % to 40 mass %, a content of the compound (b) is 35 mass % to 89.8 mass %, a content of the radical polymerization initiator (c) is 0.1 mass % to 10 mass %, and a content of the cationic polymerization initiator (d) is 0.1 mass % to 10 mass %, with respect to a total solid content in the composition for forming the hard coat layer.

6. The polarizing plate protective film of claim 1,
wherein the composition for forming the hard coat layer further comprises (e) inorganic particles reactive with an epoxy group or an ethylenically unsaturated double bond group, the inorganic particles have an average particle diameter of 10 nm to 100 nm and is contained in an amount of 5 mass % to 40 mass % with respect to a total solid content in the composition for forming the hard coat layer.

7. The polarizing plate protective film of claim 1,
wherein a maximum absorption wavelength λc of the radical polymerization initiator (c) at a wavelength of 230 nm to 500 nm, and a maximum absorption wavelength λd of the cationic polymerization initiator (d) at a wavelength of 260 nm to 500 nm satisfy Equation (3) below:
λd−λc≧30 nm Equation (3).

8. The polarizing plate protective film of claim 1,
wherein the composition for forming the hard coat layer further comprises (f) UV absorber.

9. The polarizing plate protective film of claim 8,
wherein a maximum absorption wavelength λc of the radical polymerization initiator (c) at a wavelength of 230 nm to 500 nm, a maximum absorption wavelength λd of the cationic polymerization initiator (d) at the wavelength of 260 nm to 500 nm, and a maximum absorption wavelength λf of the UV absorber (f) at a wavelength of 230 nm to 500 nm satisfy Equations (3) and (4) below:
λd−λc≧30 nm Equation (3); and
λf−λd≧60 nm Equation (4).

10. The polarizing plate protective film of claim 1,
wherein the cellulose acylate film contains a compound represented by Formula 1 below: 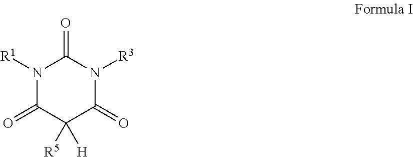
wherein in Formula I, R¹, R³, and R⁵ each independently represent a hydrogen atom, an alkyl group, a cycloalkyl group, an alkenyl group, or an aromatic group, and the alkyl group, the cycloalkyl group, the alkenyl group, and the aromatic group optionally have a substituent, provided that any one of R¹, R³, and R⁵ is an alkyl group or cycloalkyl group substituted with a group having a cyclic structure, and the number of the cyclic structure present in R¹, R³, and R⁵ is 3 or more in total.

11. A polarizing plate comprising a polarizer and at least one of the polarizing plate protective film of claim 1.

12. A liquid crystal display device comprising a liquid crystal cell, and the polarizing plate of claim 11 disposed on at least one surface of the liquid crystal cell,
wherein the polarizing plate protective film is disposed on the outermost surface of the liquid crystal display device.

13. A method for preparing a polarizing plate protective film comprising a hard coat layer having a film thickness of 3 μm to 10 μm on at least one surface of a cellulose acylate film having a thickness of 15 μm to 40 μm, wherein the polarizing plate protective film has a WVTR_{A} of 300 g/m²/day or less and a ratio WVTR_{A}/WVTR_{B} of 0.6 to 1.0 when a water vapor transmission rate under environments of a temperature of 40° C. and a relative humidity of 90% is defined as WVTR_{A} and a water vapor transmission rate under environments of a temperature of 40° C. and a relative humidity of 90% after being exposed to the environments of a temperature of 85° C. and a relative humidity of 85% for 24 hours is defined as WVTR_{B}, the method comprising:
applying, on at least one surface of the cellulose acylate film having a thickness of 15 μm to 40 μm, a composition for forming a hard coat layer containing:
(a) a compound having at least one alicyclic epoxy group in the molecule;
(b) a compound having three or more ethylenically unsaturated double bond groups in the molecule;
(c) a radical polymerization initiator; and
(d) a cationic polymerization initiator,
drying and ultraviolet-curing the composition,
wherein the ultraviolet-curing of the composition is a process in which UV rays are irradiated by setting a film-surface temperature to 40° C. or less and an irradiation dose to 30 mJ/cm² or more, and then irradiated by setting a film-surface temperature of 50° C. or more and an irradiation dose to 200 mJ/cm² or more.
